(19) United States
(12) Patent Application Publication
(10) Pub. No.: US 2024/0412303 A1
(43) Pub. Date: Dec. 12, 2024

(54) BUILDING MANAGEMENT SYSTEM WITH SUSTAINABILITY PLANNING

(71) Applicant: Tyco Fire & Security GmbH, Neuhausen am Rheinfall (CH)

(72) Inventors: Michael J. Risbeck, Madison, WI (US); Chenlu Zhang, Milwaukee, WI (US); Saman Cyrus, Fitchburg, WI (US); Young M. Lee, Old Westbury, NY (US)

(21) Appl. No.: 18/612,191

(22) Filed: Mar. 21, 2024

Related U.S. Application Data
(60) Provisional application No. 63/472,186, filed on Jun. 9, 2023.

(51) Int. Cl. G06Q 50/08

(52) U.S. Cl. CPC G06Q 50/08

(57) ABSTRACT

A Building Management System (BMS) can include one or more memory devices that can store instructions thereon that, when executed by one or more processors, cause the one or more processors to determine emission impacts for a plurality of pieces of building equipment of a building, generate a plurality of recommendations to adjust the emission impacts for the plurality of pieces of building equipment, determine a first point in time to implement at least one recommendation of the plurality of recommendations, and cause a user interface to be displayed.

### CROSS-REFERENCE TO RELATED PATENT APPLICATIONS

This application claims the benefit of and priority to U.S. Provisional Patent Application No. 63/472,186 filed on Jun. 9, 2023, the entirety of which is incorporated by reference herein.

### SUMMARY

At least one embodiment relates to a Building Management System (BMS). The BMS can include one or more memory devices. The one or more memory devices can store instructions. The instructions can cause, when executed by one or more processors, the one or more processors to determine, based on emission information, emission impacts for a plurality of pieces of building equipment of the building. The instructions can also cause the one or more processors to generate, using the emission impacts for the plurality of pieces of building equipment, a plurality of recommendations to adjust the emission impacts for the plurality of pieces of building equipment. The instructions can also cause the one or more processors to simulate, using a model, implementation of at least one recommendation of the plurality of recommendations at a plurality of points in time, based on a plurality of parameters. The instructions can also cause the one or more processors to determine, responsive to simulation of the implementation of the at least one recommendation, a first point in time of the plurality of points in time to implement the at least one recommendation of the plurality of recommendations. The implementation of the at least one recommendation of the plurality of recommendations can include controlling one or more pieces of building equipment of the plurality of pieces of building equipment The instructions can also cause the one or more processors to generate a user interface. The user interface can include a graphical representation to indicate the plurality of recommendations and an element to indicate the first point in time to implement the at least one recommendation of the plurality of recommendations. The instructions can also cause the one or more processors to cause the user interface to be displayed.

In some embodiments, the instructions can further cause the one or more processors to identify, responsive to simulation of the implementation of the at least one recommendation, one or more points in time of the plurality of points in time predicted to correspond to a predetermined level of emission performance. The instructions can also cause the one or more processors can also determine, from the one or more points in time, the first point in time to implement the at least one recommendation of the plurality of recommendations based on an amount of time to obtain the predetermined level of emission performance.

In some embodiments, the user interface can include a plurality of selectable elements associated with the plurality of recommendations. The instructions can also cause the one or more processors to receive, via a user device displaying the user interface, an indication of a selection of a first selectable element of the plurality of selectable elements, the first selectable element can be associated with a first recommendation of the plurality of recommendations. The instructions can also cause the one or more processors to identify, responsive to receipt of the indication, a modification to change implementation of the first recommendation from a second point in time to a third point in time. The instructions can also cause the one or more processors to transmit, to the user device, one or more signals to cause the user device to update the user interface to reflect implementation of the first recommendation at the third point in time.

In some embodiments, the instructions can cause the one or more processors to input, into the model, one or more parameters associated with implementation of the first recommendation at the third point in time. The instructions can also cause the one or more processors to determine, using the model, an adjustment to an emission impact of the emission impacts for a first piece of building equipment of the plurality of pieces of building equipment based on implementation of the first recommendation at the third point in time. The instructions can also cause the one or more processors to transmit, to the user device, one or more second signals to cause the user device to update the user interface to indicate the adjustment to the emission impact.

In some embodiments, the instructions can cause the one or more processors to input, into the model, one or more parameters associated with implementation of the first recommendation at the third point in time. The instructions can also cause the one or more processors to identify, using the model, one or more second recommendations of the plurality of recommendations to modify implementation from one or more fourth points in time to one or more fifth points in time based on the implementation of the first recommendation at the third point in time. The instructions can also cause the one or more processors to transmit, to the user device, one or more second signals to cause the user device to update the user interface to indicate implementation of the one or more second recommendations at the one or more fifth points in time.

In some embodiments, the plurality of parameters to input into the model to simulate implementation of the at least one recommendation of the plurality of recommendations may correspond to at least one of the plurality of points in time or one or more Energy Conservation Measures associated with the at least one recommendation of plurality of recommendations.

In some embodiments, the user interface has a plurality of selectable elements associated with the plurality of recommendations. The instructions further cause the one or more processors to receive, from a user device displaying the user interface, an indication of a selection of a first selectable element of the plurality of selectable elements, the first selectable element associated with a first recommendation of the plurality of recommendations. The instructions further cause the one or more processors to determine, responsive to receipt of the indication, that the selection defines a second point in time to implement the first recommendation. The instructions further cause the one or more processors to transmit, to the user device, one or more signals to cause the user device to update the user interface to reflect implementation of the first recommendation at the second point in time.

In some embodiments, the instructions cause the one or more processors to modify, based on the selection defining the second point in time, one or more parameters associated with simulating implementation of the first recommendation to prevent an adjustment to the second point in time without receipt of a subsequent selection. The instructions further cause the one or more processors to transmit, responsive to detection of the second point in time, one or more second signals to implement the first recommendation. The instructions further cause the one or more processors to detect, responsive to implementation of the first recommendation, a change to an emission impact of the emission impacts to a first piece of building equipment of the plurality of pieces of building equipment. The instructions further cause the one or more processors to transmit, responsive to detection of the change, one or more third signals to cause the user device to update the user interface to indicate the change to the emission impact.

In some embodiments, the user interface includes a plurality of selectable elements associated with the plurality of recommendations. In some embodiments, interactions with one or more selectable elements of the plurality of selectable elements adjust one or more parameters associated with implementation of one or more recommendations of the plurality of recommendations. In some embodiments, the instructions further cause the one or more processors to receive, from a user device displaying the user interface, an indication of a selection of a first selectable element of the plurality of selectable elements, the first selectable element associated with a first recommendation of the plurality of recommendations. The instructions further cause the one or more processors to adjust, responsive to receipt of the indication of the selection, one or more parameters associated with the first recommendation. The instructions further cause the one or more processors to determine, responsive to adjusting the one or more parameters, one or more subsequent changes to one or more points in time to implement one or more recommendations of the plurality of recommendations to consider the adjustment to the one or more parameters associated with the first recommendation.

In some embodiments, implementation of the at least one recommendation results in an adjustment of an emission score for the building from a first value to a second value, and the adjustment of the emission score for the building includes at least one of a reduction in carbon emissions for the building or a reduction in energy consumption for the building.

At least one embodiment relates to a method. The method can include determining, by one or more processing circuits, based on emission information, emission impacts for a plurality of pieces of building equipment of the building. The method can also include generating, by the one or more processing circuits, using the emission impacts for the plurality of pieces of building equipment, a plurality of recommendations to adjust the emission impacts for the plurality of pieces of building equipment. The method can also include simulating, by the one or more processing circuits, using a model, a plurality of parameters to simulate implementation of at least one recommendation of the plurality of recommendations at a plurality of points in time. The method can also include determining, by the one or more processing circuits, responsive to simulation of the implementation of the at least one recommendation, a first point in time of the plurality of points in time to implement the at least one recommendation of the plurality of recommendations. The method can also include generating, by the one or more processing circuits, responsive to determining the first point in time, a user interface. The user interface can include a graphical representation to indicate the plurality of recommendations. The user interface can also include an element to indicate the first point in time to implement the at least one recommendation of the plurality of recommendations. The method can also include causing, by the one or more processing circuits, the user interface to be displayed.

In some embodiments, the method further includes identifying, by the one or more processing circuits, responsive to simulation of the implementation of the at least one recommendation, one or more points in time of the plurality of points in time predicted to correspond to a predetermined level of emission performance. The method can further include determining, by the one or more processing circuits, from the one or more points in time, the first point in time to implement the at least one recommendation of the plurality of recommendations based on an amount of time to obtain the predetermined level of emission performance.

In some embodiments, the user interface includes a plurality of selectable elements associated with the plurality of recommendations. The method can further include receiving, by the one or more processing circuits via a user device displaying the user interface, an indication of a selection of a first selectable element of the plurality of selectable elements. The first selectable element can be associated with a first recommendation of the plurality of recommendations. The method can further include identifying, by the one or more processing circuits, responsive to receipt of the indication, a modification to change implementation of the first recommendation from a second point in time to a third point in time. The method can further include transmitting, by the one or more processing circuits, to the user device, one or more signals to cause the user device to update the user interface to reflect implementation of the first recommendation at the third point in time.

In some embodiments, the method can further include inputting, by the one or more processing circuits, into the model, one or more parameters associated with implementation of the first recommendation at the third point in time. The method can further include determining, by the one or more processing circuits, using the model, an adjustment to an emission impact of the emission impacts for a first piece of building equipment of the plurality of pieces of building equipment based on implementation of the first recommendation at the third point in time. The method can further include transmitting, by the one or more processing circuits, to the user device, one or more second signals to cause the user device to update the user interface to indicate the adjustment to the emission impact.

In some embodiments, the method further can include inputting, by the one or more processing circuits, into the model, one or more parameters associated with implementation of the first recommendation at the third point in time. The method can further include identifying, by the one or more processing circuits, using the model, one or more second recommendations of the plurality of recommendations to modify implementation from one or more fourth points in time to one or more fifth points in time based on the implementation of the first recommendation at the third point in time. The method can further include transmitting, by the one or more processing circuits, to the user device, one or more second signals to cause the user device to update the user interface to indicate implementation of the one or more second recommendations at the one or more fifth points in time.

In some embodiments, the user interface includes a plurality of selectable elements associated with the plurality of recommendations. Interactions with one or more selectable elements of the plurality of selectable elements adjust one or more parameters associated with implementation of one or more recommendations of the plurality of recommendations. The one or more processing circuits are configured to receive, from a user device displaying the user interface, an indication of a selection of a first selectable element of the plurality of selectable elements. The first selectable element is associated with a first recommendation of the plurality of recommendations. The one or more processing circuits are also configured to adjust, responsive to receipt of the indication of the selection, one or more parameters associated with the first recommendation. The one or more processing circuits are also configured to determine, responsive to adjusting the one or more parameters, one or more subsequent changes to one or more points in time to implement one or more recommendations of the plurality of recommendations to consider the adjustment to the one or more parameters associated with the first recommendation.

In some embodiments, implementation of the at least one recommendation results in an adjustment of an emission score for the building from a first value to a second value. In some embodiments, the adjustment of the emission score for the building includes at least one of a reduction in carbon emissions for the building or a reduction in energy consumption for the building.

At least one embodiment relates to one or more non-transitory storage media storing instructions thereon that, when executed by one or more processors, cause the one or more processors to receive, from a data source, emission information corresponding to a building. The instructions can also cause the one or more processors to determine, based on the emission information, emission impacts for a plurality of pieces of building equipment of the building. The instructions can also cause the one or more processors to generate, using the emission impacts for the plurality of pieces of building equipment, a plurality of recommendations to adjust the emission impacts for the plurality of pieces of building equipment. The instructions can also cause the one or more processors to determine, based on predetermined criteria, a first point in time to implement at least one recommendation of the plurality of recommendations. The instructions can also cause the one or more processors to cause, responsive to determining the first point in time, a user interface to be displayed. The user interface can include a graphical representation to indicate the plurality of recommendations. The user interface can also include an element to indicate the first point in time to implement the at least one recommendation of the plurality of recommendations.

In some embodiments, the user interface includes a plurality of selectable elements associated with the plurality of recommendations. The instructions may further cause the one or more processors to perform operations including receiving an indication of a selection of a first selectable element of the plurality of selectable elements. The first selectable element can be associated with a first recommendation of the plurality of recommendations. The instructions can also cause the one or more processors to perform operations including determining, responsive to receipt of the indication, that the selection defines a second point in time to implement the first recommendation. The instructions can also cause the one or more processors to perform operations including updating the user interface to reflect implementation of the first recommendation at the second point in time.

In some embodiments, the instructions can also cause the one or more processors to perform operations including modifying, based on a selection defining a second point in time, one or more parameters associated with simulating implementation of a first recommendation to prevent an adjustment to the second point in time without receipt of a subsequent selection. The instructions can also cause the one or more processors to perform operations including transmitting, responsive to detection of the second point in time, one or more signals to implement the first recommendation. The instructions can also cause the one or more processors to perform operations including detecting, responsive to implementation of the first recommendation, a change to an emission impact of the emission impacts to a first piece of building equipment of the plurality of pieces of building equipment. The instructions can also cause the one or more processors to perform operations including updating the user interface to indicate the change to the emission impact.

### BRIEF DESCRIPTION OF THE DRAWINGS

FIG. 1 is a drawing of a building equipped with a heating, ventilation, and/or air conditioning (HVAC system, according to an exemplary embodiment.

FIG. 2 is a block diagram of a building automation system (BAS) that may be used to monitor and/or control the building of FIG. 1, according to an exemplary embodiment.

FIG. 3 is a block diagram of a system for sustainability optimization for planning a building, according to an exemplary embodiment.

FIG. 4 is a block diagram of an energy information retrieval system of the sustainability optimization system of FIG. 3, the energy information retrieval system retrieving utility information for the building, according to an exemplary embodiment.

FIG. 5 is a block diagram of a building audit system of the system of FIG. 3, the facility audit system configured to collect building data of the building via an audit, according to an exemplary embodiment.

FIG. 6 is a block diagram of a demand side data system of the system of FIG. 3, the demand side data system configured to collect building system and operational data from a building and calculate energy metrics, carbon metrics, operational metrics, and facility improvement measures (FIMs) for the building, according to an exemplary embodiment.

FIG. 7 is a block diagram of an on-site supply data system of the system of FIG. 3, the on-site supply system configured to collect data from an on-site energy supply system for the building, according to an exemplary embodiment.

FIG. 8 is a block diagram of a sustainability advisor and an optimization system of the system of FIG. 3, the sustainability advisor configured to provide sustainability data to a user and receive input from the user and the optimization system configured to run sustainability optimizations for the building, according to an exemplary embodiment.

FIG. 9 is a block diagram of a planning tool which can be used to determine the benefits of investing in a battery asset and calculate various financial metrics associated with the investment, according to an exemplary embodiment.

FIG. 10 is a block diagram illustrating the asset sizing module, according to an exemplary embodiment.

FIG. 11 is a block diagram of a system for use in optimizing energy conservation measures, according to an exemplary embodiment.

FIG. 12 is an illustration of a user interface including information generated by the system of FIG. 11, according to an exemplary embodiment.

FIG. 13 is an illustration user interface including information generated by the system of FIG. 11, according to an exemplary embodiment.

FIG. 14 is an illustration of a planning portion included in the user interface illustrated in FIG. 12, according to an exemplary embodiment.

FIG. 15 is an illustration of a performance portion included in the user interface illustrated in FIG. 12, according to an exemplary embodiment.

FIG. 16 is an illustration of a decisions portion included in the user interface illustrated in FIG. 12, according to an exemplary embodiment.

FIG. 17 is an illustration of a customization portion included in the planning portion of the user interface illustrated in FIG. 13, according to an exemplary embodiment.

FIG. 18 is an illustration of a user interface including information generated by the system illustrated in FIG. 11, according to an exemplary embodiment.

FIG. 19 is a flow diagram of a method for optimizing energy conservation measures, according to an exemplary embodiment.

FIG. 20 is a flow diagram of a method to train one or more Machine Learning models, according to an exemplary embodiment.

### DETAILED DESCRIPTION

Referring generally to the FIGURES, systems and methods are provided for sustainability assessment and/or optimization for a building, according to various exemplary embodiments. An energy conservation measure (ECM) optimization system can collect various pieces of information regarding emission information for a building (e.g., energy consumption, carbon emissions, water consumption, waste production, transportation information, etc.). The ECM optimization system can run an optimization on the emission information to determine recommended actions or measures to implement in the building to adjust emissions. For example, the ECM optimization system can obtain emission information for a given building and the ECM optimization system can determine a set of actions to adjust the emissions impacts of the building. The ECM optimization system can also determine one or more points in time to implement the recommended action or actions.

Buildings have been shown to be responsible for one third of total energy consumption, as well as 40% of total carbon emissions in both the United States and the European Union. Reducing building emissions may result in improving sustainability and reducing the effects of climate change. However, reducing building emissions may include reductions in in energy consumption and a transition to renewable energy sources. There may be challenges and obstacles associated with reducing building emissions, which may lead to hesitation among some stakeholders. With appropriate modeling and guidance, improvements are readily achievable, albeit with associated cost, in many buildings.

Reductions in energy consumption may include targeting for “net-zero” energy consumption or carbon emissions. Net-zero can also be referred to as being “energy neutral,” and it is sometimes qualified with “nearly.” For a building to achieve net-zero status would mean that the net energy obtained from utilities, or the carbon emissions thereof, are balanced against renewable energy generated on-site and possibly sold back to the grid. There are various definitions of net-zero, including import/export or load/generation, and they are typically applied over a specific time interval, usually annually. Typically, the directly measured quantity is energy consumption (either as electricity, natural gas, or fuel oil, for example), but weighting factors can be applied to re-cast the balance in terms of carbon emissions or primary energy use. Alternatively, reducing building emissions may focus directly on reducing energy consumption.

Various entities (e.g., elected officials, regulatory boards, legislative branches, etc.) have encouraged buildings to reduce carbon emissions. As an example, the European Union, has established guidelines that new buildings strive for nearly net-zero energy consumption.

Reductions in building emissions may also include aiming to achieve “life-cycle” net-zero status over an entire operating lifetime. The thought process for this extension is that the construction of the building itself is a significant source of energy consumption and carbon emissions, which means even with net-zero operation, the building may still have a negative impact on the environment. Such a goal can be achieved in new buildings beginning at the design phase, but it is challenging in existing buildings, as net-negative operation may be required to overcome past consumption. Thus, for existing buildings, the focus is primarily on operational net-zero and other similar operational goals in this work.

Achieving net-zero carbon emissions may be more difficult than net-zero energy use depending on what utilities are available. In areas where electricity generation is primarily achieved via coal or other fossil fuels, reducing energy consumption may be beneficial to counteract emission factors associated with electricity generation using coal or other fossil fuels. Particularly in developing countries, this challenge may be compounded by uncertainty in long-term economic returns, lack of legislative support, and resistance to change. By contrast, in locations where high-efficiency district heating or cooling is available, expensive retrofits may not be avoidable, as efficiency improvements can be implemented at the district level.

Achieving net-zero status for existing buildings generally requires significant modification to the design of the building, and thus it is not a straightforward task. The typical age of most buildings represents both a challenge and an opportunity for sustainability improvements. In Europe, more than 25% of buildings are over 70 years old, and the annual replacement rate is only 1% to 3%. Thus, it is predicted that 75% to 90% of existing building will still be in service by 2050. Similarly, 52% of residential buildings in the United States were built prior to 1980.

Improving energy efficiency of existing buildings may involve implementations of energy conservation measures (ECMs) or other retrofits, including, for example, modifications to building structure, occupants' behavior, or building equipment with the goal of reducing total energy consumption. Actions to reduce total energy consumption could include, for example, enhancing wall or roof installation, improving building air-tightness, replacing windows, upgrading to more efficient heating and cooling equipment, enhancing lighting with automatic controls, and switching to different fuel sources. Such retrofits may be assist in decreasing energy consumption to a level that can be offset via renewable energy sources, perhaps installed on site.

Any design changes or retrofits may affect other objectives, such as, for example, total cost or occupant comfort, which may need to be considered during planning. For example, prioritizing cost-optimality may compromise a building's ability to achieve net-zero energy consumption. Therefore, it may be necessary to use a multi-objective optimization process when making decisions, and various simulation tools have been developed for this purpose. Such optimization may involve multiple design parameters that may need to be considered. Available options may also be different for buildings that are being newly built versus existing buildings that will be modified.

Multiple approaches may be employed to make design and retrofit decisions for buildings. For example, alternative scenarios may be generated based on analysis provided by an energy expert. This strategy can be costly and may not explore a full combinatorial space when multiple decisions are being made. In another example, simulation tools may be utilized within a multi-objective process, which means that numerous alternative retrofitting choices can be considered along with the associated tradeoffs. Different optimization strategies, may include mixed-integer linear programming, Monte-Carlo analysis, and genetic algorithms, can be employed based on a specific formulation being used. However, many existing formulations consider only which design changes are implemented and not when they need to be made, which can limit available insights of these approaches.

Once retrofits or ECMs have been put in place, efficiently operating the buildings may impact whether the building achieves the established sustainability goals. For example, sites may make use of energy storage to temporally decouple utility obtainment from actual use, thereby reducing overall energy consumption. Such operation may require advanced control strategies, such as, for example, model predictive control to be employed. These strategies can account for cumulative constraints on energy consumption as needed to achieve net-zero status, and they can be used in predictive scheduling and real-time optimal control of energy systems. The forward-looking nature of the strategies can also facilitate further efficiency improvements by shifting energy demand away from peak periods, thus reducing strain on a power grid and improving overall primary energy efficiency.

Application of some of the control strategies described above may not be sufficient to achieve net-zero status or other sustainability goals. Due to inherent uncertainty associated with energy demand and generation capacity, a nominally correct design (i.e., that can achieve goals in a mean case) may not lead to the target value (e.g., net-zero). Thus, reaching the sustainability goal (in this case, net-zero energy consumption) may only be achieved about 50% of the time. In cases where consumption is higher or generation is lower than expected, discretionary actions may be implemented to further reduce energy consumption. For example adjusting setpoints of building thermostats or obtaining emissions credits. Determining if and when such actions are implemented is complicated, given the somewhat roundabout path of net energy throughout the year.

Some of the technical solutions described herein include an ECM optimization system that generates, using one or more modeling techniques, recommended sustainability measures to implement in a building to improve its sustainability. The ECM optimization system implementing modeling and recommendations, may result in improvements to building sustainability. The ECM optimization system can, when given constraints (i.e., cost constraints), generate points in time at which actions can be implemented to improve a building's sustainability while minimizing costs. The ECM optimization system can also detect operational changes that can be utilized to update the points in time at which actions can be implemented. For example, the ECM optimization system can detect that a budget has decreased for a year of a business, which may require the business to adjust one or more sustainability actions that year. The ECM optimization system can detect the budget change and recompute a model for the implementation of sustainability actions that takes the new budget into consideration.

To assist building managers or other users in decision-making to achieve net-zero energy use and other sustainability goals, the ECM optimization system may implement an optimization problem to determine which design changes and operational actions to take to meet those goals. An optimization space for the optimization problem includes choosing which decisions to take and when to take them. When employed for design optimization, the problem can cover a multi-year horizon and chooses from a set of decisions so that a resulting consumption (net or absolute) of energy or other resources (as predicted from forecasts of baseline consumption and estimates of the reduction provided by each decision) is at or below given targets. The results can allow users to prioritize and schedule design changes that meet their goals. Once design changes have been implemented, the formulation can also be used for operational planning, in which discretionary curtailment actions are chosen to meet the current period's sustainability targets. By applying the problem in closed-loop, curtailment plans can be updated based on actual realizations of energy consumption and generation, thus minimizing the impact of uncertainty via regular feedback. Parameters used in both formulations can be predicted by, for example, lightweight data-driven models, thus tailoring the resulting decisions to specifics of each building, even if only a modest amount of historical data is available. The proposed optimization strategy enables efficient scheduling of design decisions, and ensures that established goals can be met through appropriate operation.

The formulation accounts for both design optimization and closed-loop operational planning to ensure optimal decision-making throughout the full sustainability horizon. The formulation is first used for design optimization, in which design changes and operational actions are scheduled so as to meet sustainability goals over a multi-year horizon. While design changes are being implemented, the formulation is also used to plan discretionary curtailment actions as needed to stay on track to meet end-of-year targets. Instances can be solved efficiently using dynamic programming, and an approximate MILP reformulation is available for larger problems. Parameters to be implemented can be provided by lightweight data-driven models. Reasonably accurate models can be fit to historical data and used for both design optimization and operational planning purposes. Optimized solutions provide the decisions necessary to satisfy imposed constraints at minimal cost.

### Building Management System and HVAC System

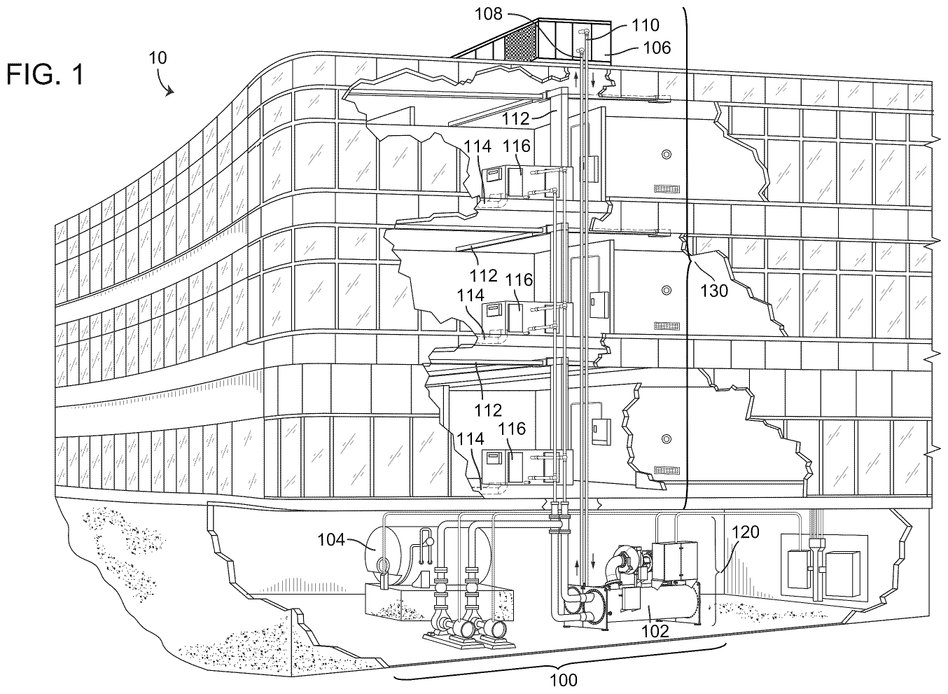

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and/or any other system that is capable of managing building functions or devices, or any combination thereof.

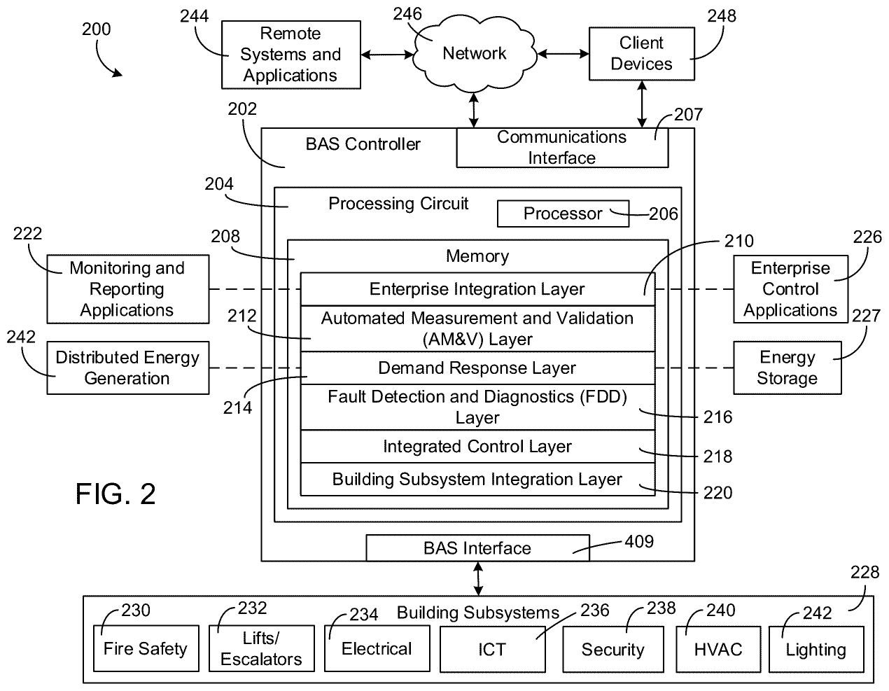

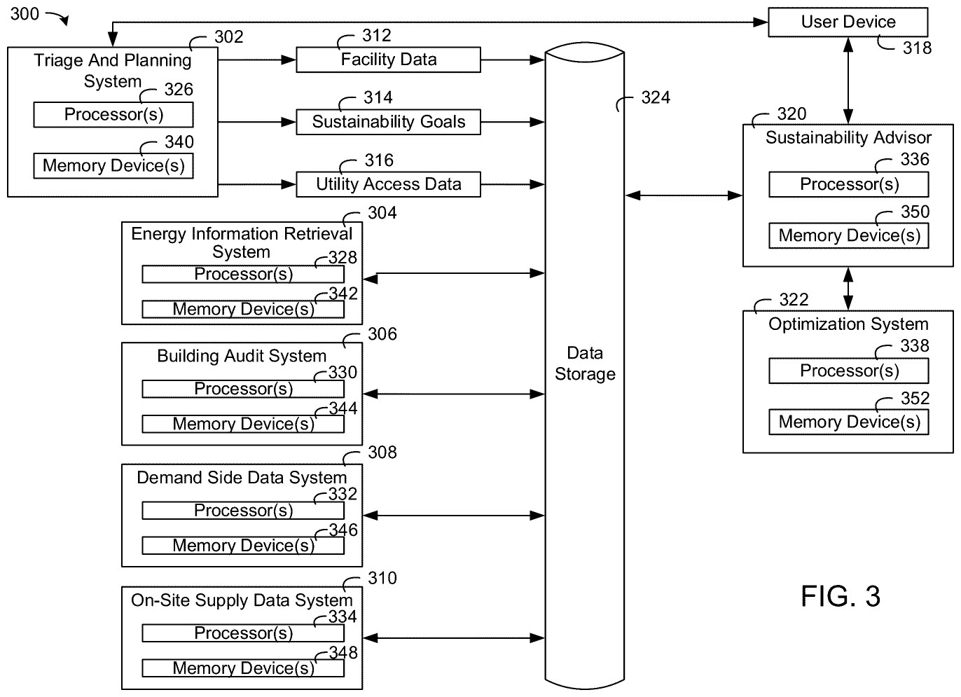

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include BAS controller 202 and building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. patent application Ser. No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 202 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 202 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 2 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 is configured to receive inputs from building subsystems 228 and other data sources, determine optimal control actions for building subsystems 228 based on the inputs, generate control signals based on the optimal control actions, and provide the generated control signals to building subsystems 228 in some embodiments. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across multi-vendor/multi-protocol systems.

Demand response layer 214 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable setpoint adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

Referring now to FIG. 3, a system 300 for sustainability optimization for planning a building is shown, according to an exemplary embodiment. The system 300 includes a triage and planning system 302 that is configured to interact with a user, via a user device 318. The system 300 further includes an energy information retrieval system 304 configured to retrieve energy information for a building. The system 300 further includes a building audit system 306 configured to collect and aggregate audit data for the building. The system 300 further includes a demand side data system 308 configured to collect demand related data from various building subsystems of a building.

Furthermore, the system 300 includes an on-site supply data system 310 configured to collect data regarding on-site supply systems of the building. Furthermore, the system 300 includes a sustainability advisor 320 configured to present sustainability related optimization results to a user via the user device 318. The system 300 includes an optimization system 322 configured to run an optimization that can identify optimal building retrofit decisions, building improvements, and/or operating plans.

The components of the system 300 can, in some embodiments, be run as instructions on one or more processors. The instructions can be stored in various memory devices. The processors can be the processors 326-338 and the memory devices can be the memory devices 340-352. The processors 326-338 can be implemented as a general purpose processor, an application specific integrated circuit (ASIC), one or more field programmable gate arrays (FPGAs), a group of processing components, or other suitable electronic processing components. The memory devices 340-352 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory devices 340-352 can be or include volatile memory and/or non-volatile memory.

The memory devices 340-352 can include object code components, script components, or any other type of information structure for supporting the various activities and information structures described in the present application. According to some embodiments, the memory devices 340-352 are communicably connected to the processors 326-338 and can include computer code for executing (e.g., by the processors 326-338) one or more processes of functionality described herein.

The system 300 includes data storage 324. The data storage 324 can be a database, a data warehouse, a data lake, a data lake-house, etc. The data storage 324 can store raw data, aggregated data, annotated data, formatted data, etc. The data storage 324 can act as a repository for all data collected from the triage and planning system 302, the energy information retrieval system 304, the building audit system 306, the demand side data system 308, the on-site supply data system 310, the sustainability advisor 320, the optimization system 322, and/or any other system. In some embodiments, the data storage 324 can, in some embodiments, be a digital twin. The digital twin can, in some embodiments, be a graph data structure. The digital twin can be the digital twin described with reference to U.S. patent application Ser. No. 17/134,664 filed Dec. 28, 2020.

The triage and planning system 302 can provide one or more user interfaces to a user via the user device 318. The user interfaces can allow the user to interact and provide various pieces of information describing a building while the building is in a design phase and/or for an onboarding phase where a user first registers with the system 300 to begin sustainability planning for their building. The triage and planning system 302 can receive facility data 312, sustainability goals 314, and/or utility access data 316. The facility data 312 can describe a building facility, e.g., provide a name of the facility or campus, identify a number of buildings in the facility or campus, identify a use of each building, include a name of each building, indicate campus layout, indicate building size, indicate building square footage, indicate campus square footage, indicate geographic location, etc.

The triage and planning system 302 can receive sustainability goals 314 from the user devices 318. The sustainability goals 314 can be customer goals for their building with respect to energy reduction, carbon creation, carbon footprint, water usage reduction, switching to renewable energy, obtaining a certain number of renewable energy credits, etc. The goals can include target levels for energy consumption, carbon production, net zero carbon emissions, renewable energy, etc. The goals can further include timelines for the various target levels. For example, the timeline could be a period of time into the future, e.g., a number of days, weeks, months, years, decades, etc. The timeline can indicate a target date. For example, the timeline could be that a building is energy independent in the next forty years, or that the building is at a net-zero carbon emissions level in the next twenty five years. In some embodiments, the timelines for the sustainability goals can be returned to the user via the user device 318 with recommendations for meeting certain goals, e.g., a recommendation could be to extend a recommendation by five years (e.g., to 25 year) to hit a certain carbon emissions level which would be more financially feasible than attempting to meet the carbon emissions level in 20 years.

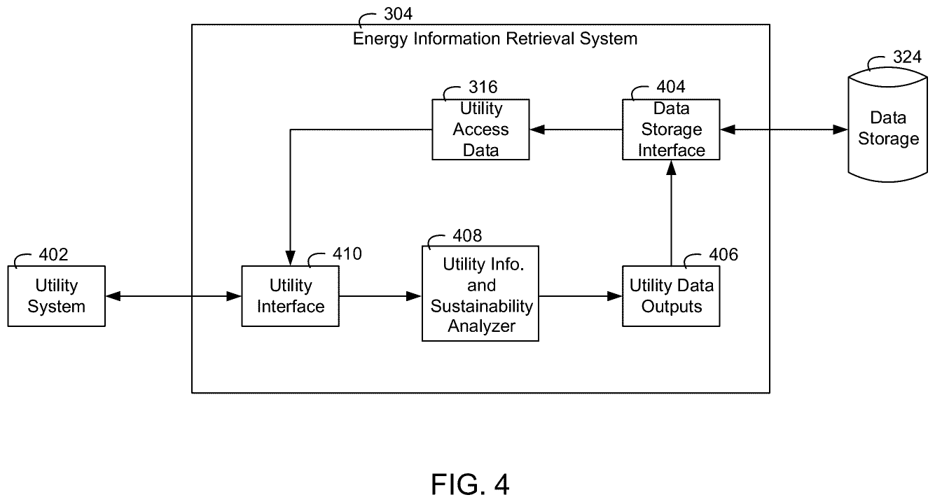

Referring now to FIG. 4, energy information retrieval system 304 of the system 300, the energy information retrieval system retrieves utility information for the building, according to an exemplary embodiment. The energy information retrieval system 304 can be configured to retrieve utility access data 316 from the data storage 324 via a data storage interface 404. The information can be electric information, natural gas information, water information, etc. The information may be, for example, a usage amount of the energy for a certain time period. For example, the natural gas information may indicate usage over a one month period. The data storage interface 404 can be an interface that integrates with the data storage 324 via an application programming interface (API) or otherwise exposes and API to external systems. A utility interface 410 can receive the utility access data 316 and retrieve utility information from a utility system 402 based on the utility access data 316. The utility access data 316 can include a username, a login credential, an email address, an access code, an account number, a name of the energy provider, etc.

A utility interface 410 can, in some embodiments, integrate with the utility system 402 via the utility access data 316. The utility information can include electricity consumption, water consumption, gas consumption, solar power electric consumption, wind turbine electric consumption, the utility interface 410 can provide the energy information to a utility information and sustainability analyzer 408. The analyzer 408 can run various analytics on the utility information.

For example, the analyzer 408 could identify information data, perform an audit on utility information data, and/or perform an analysis on energy rates and/or tariffs for the energy (e.g., environmental penalties for various forms of energy). The analyzer 408 can identify an energy consumption baseline for the building, identify benchmarking for the building (e.g., compare the baseline of the building to other peer buildings or an industry to determine a benchmark index), determine facility key performance indicators (KPIs), etc.

The analyzer 408 can identify sustainability data, for example, a carbon emissions baseline for the building (e.g., carbon emissions produced from natural gas or carbon emissions from electricity consumption), sustainability benchmarking (e.g., a peer comparison of the emissions baseline for the building against other buildings), renewable energy usage tracking, etc. The analyzer 408 can generate sustainability reports (e.g., an indication between a baseline emissions and a current emissions to show sustainability tracking), management and verification (M&V) reports, etc. The results of the analysis performed by the analyzer 408 can be the utility data outputs 406 which can be stored in the data storage 324 by the data storage interface 404. In some embodiments, the M&V reporting could illustrate savings between a baseline and an improvement for the building. For example, the M&V reporting could indicate a carbon emissions reduction that results (compared to a baseline) from a particular FIM.

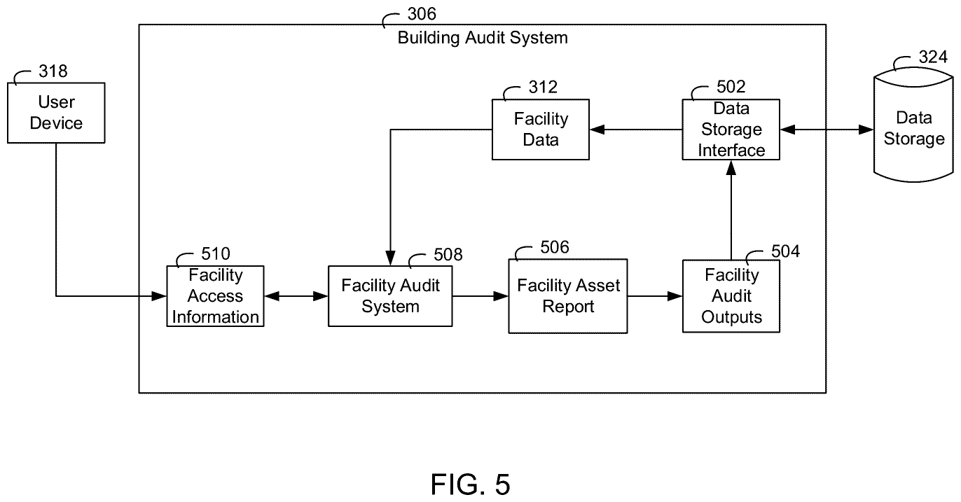

Referring now to FIG. 5, the building audit system 306 of the system 300 is shown, the building audit system 306 is configured to collect building data of the building via an audit, according to an exemplary embodiment. The building audit system 306 includes a data storage interface 502 that can be the same as, or similar to the data storage interface 404. The interface 504 can retrieve the facility data 312 from the data storage 324. The facility data 312 can be provided to a facility audit system 508. Furthermore, a user, via the user device 318, can provide facility access information 510 (e.g., key codes, registration details, access directions, etc.) to the facility audit system 508. The facility audit system 508 can receive audit details from audit personnel who visit the physical building and record information regarding the building.

Based on the audit data collected by the audit personnel and provided to facility audit system 508, the facility audit system 508 can compile a facility asset report 506. The facility asset report can include information such as a detailed facility description. The facility description can identify each room, zone, and/or floor of a building and indicate the square footage and/or ceiling height of each area of the building. The report 506 can include an equipment inventory. The equipment inventory can indicate the number, make, model, etc. of each piece of equipment in the building. For example, the number and type of chillers in the building could be indicated in the report 506. Furthermore, a maintenance log of all maintenance operations of equipment inventory can be included in the report 506. Furthermore, the report 506 could include photos of all pieces of equipment of the building. The report 506 could further include building envelop information. The result of all the audit outputs of the system 508, including the facility asset report 506, can be stored in the data storage 324 by the data storage interface 502.

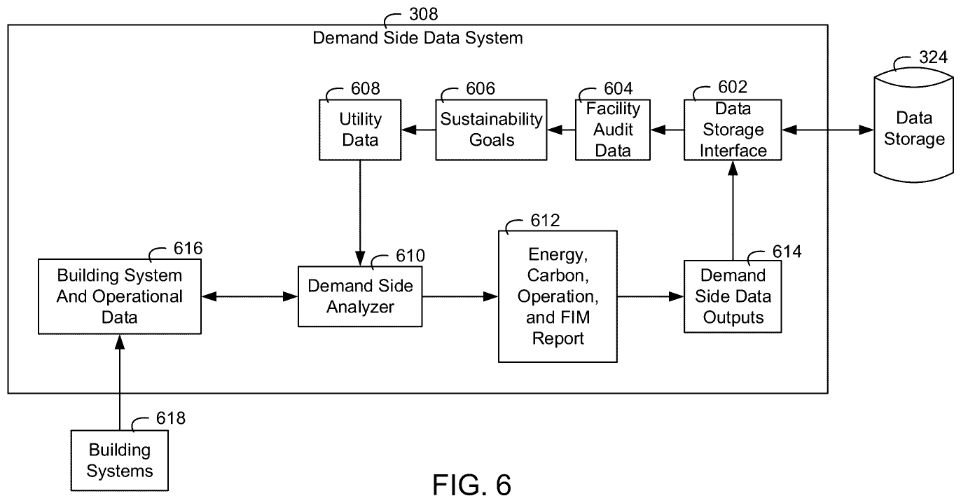

Referring now to FIG. 6, a demand side data system 308 of the system 300, the demand side data system configured to collect building system and operational data from a building and calculate energy metrics, carbon metrics, operational metrics, and facility improvement measures (FIMs) for the building, according to an exemplary embodiment. The system 308 can retrieve facility audit data 604, sustainability goals 606, and/or utility data 608 from the data storage 324 via the data storage interface 602. The data storage interface 602 can be the same as, or similar to, the data storage interface 404. A demand side analyzer 610 can receive the data 604-608. Furthermore, the demand side analyzer 610 can receive building system and/or operational data 616 from the building systems 618. The building system and/or operational data 616 could be metadata for building systems, operating settings for the building systems, runtime data for the building systems, energy usage for the building systems 618, etc. The building systems 618 can be fire safety systems, environmental cooling systems, environmental heating systems, ventilation systems, lighting systems, etc. The building systems 618 can be the systems described with reference to FIGS. 1 and 2.

The demand side analyzer 610 can run an analysis based on the demand related data 604-608 and the building system and/or operational data 616. The analyzer 610 can generate the report 612. The report 612 can indicate an energy breakdown and/or carbon breakdown for demand related systems of the building, e.g., systems that consume energy. The report 612 can indicate an energy consumption level and/or a carbon emissions level for cooling systems of a building, heating systems of a building, lighting systems of the building, etc. The energy consumption level and/or carbon emission level can attribute a portion (e.g., a percentage) of total building energy consumption and/or carbon emissions to specific pieces of equipment, equipment subsystems, subsystem types, building operation modes (heating or cooling), etc.

The analyzer 610 can further identify facility improvement measures (FIMs) for improving and/or reducing energy usage and/or carbon emissions of the building. The FIMs could be replacing a boiler with a newer energy efficient boiler which would result in a particular reduction in energy consumption and/or carbon emission. Furthermore, the analyzer 610 can identify operational improvements, e.g., reducing a temperature setpoint by one degree fahrenheit during heating over a particular time period to result in a particular energy reduction and/or carbon emissions production. The report 612 can include savings reports. The report 612 can be provided as a demand side data outputs 614 to the interface 602. The interface 602 can store the outputs 614 in the data storage 324. In some embodiments, if the demand side data system 308 is unable to pull data from the building systems 618, the building audit system 306 retrieves the data (e.g., via manual reporting, such as from a building manager, or via other methods).

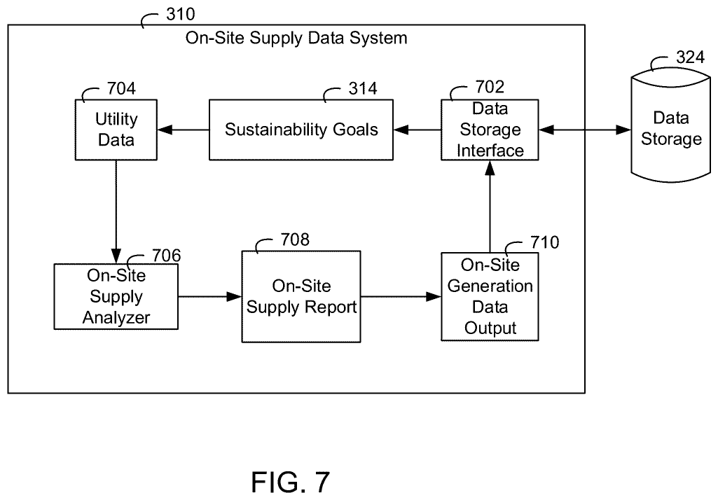

Referring now to FIG. 7, the on-site supply data system 310 is shown, the on-site supply data system 310 is configured to collect data regarding an on-site energy supply system for the building, according to an exemplary embodiment. The on-site supply data system 310 can include a data storage interface 702 configured to retrieve data from the data storage 324, e.g., the sustainability goals 314 and/or utility data 704 determined by the system 304. The interface 702 can be similar to or the same as the interface 404 described with reference to FIG. 4.

An on-site supply analyzer 706 can analyze the utility data 704 and/or the sustainability goals 314 to determine an on-site supply report 708 that can be stored as on-site generation data output 710 in the data storage 324 by the interface 702. The analyzer 706 can analyze the utility data 704 and/or the sustainability goals 314 to identify opportunities to reduce energy usage and/or carbon emissions through on-site energy supply systems, e.g., solar panels, wind power, hydro-electric dams, re-chargeable batteries, etc. The analyzer 706 can identify opportunities to shift power consumption from an energy grid to an on-site energy supply system.

The report 708 can include the results of an analysis on solar photovoltaic (PV) cells, fuel cells, energy storage, etc. The report 708 can further indicate a renewable energy report, e.g., reports on opportunities to shift energy consumption of the building to renewable energy sources that are on-site. The report 708 can further indicate cost savings for energy, e.g., if solar PV cells were installed in a building, how much financial savings in energy cost would result. Furthermore, the report 708 can indicate sustainability data, e.g., how much carbon savings or carbon production would result from consuming various amounts of energy from on-site PV cells, on-site wind turbines, etc.

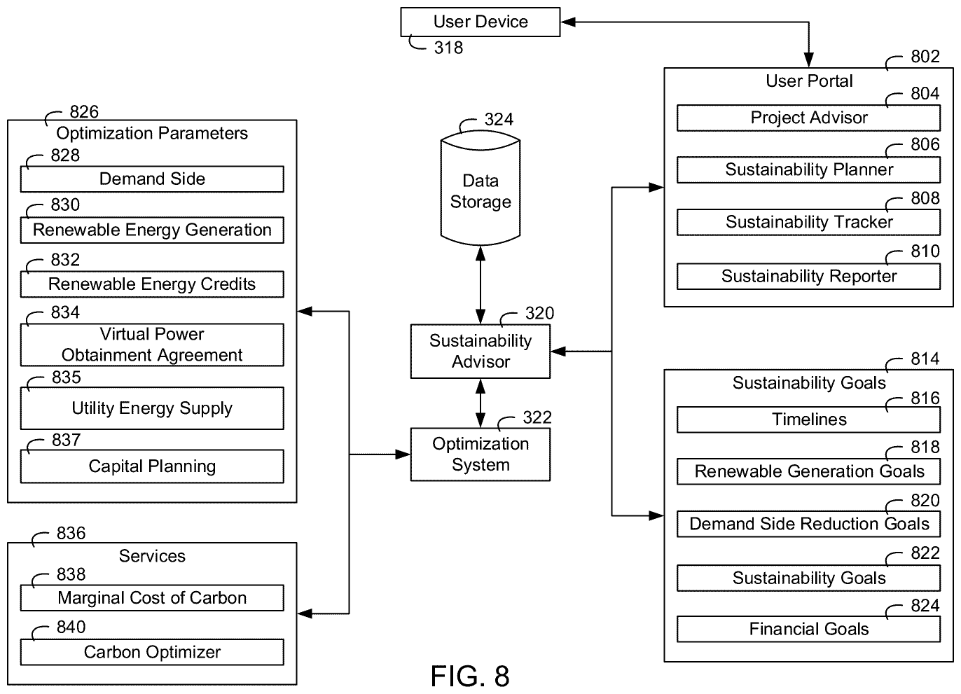

Referring now to FIG. 8, the sustainability advisor 320 and the optimization system 322 are shown, the sustainability advisor 320 is configured to provide sustainability data to a user and receive input from the user and the optimization system 322 is configured to run sustainability optimizations for the building, according to an exemplary embodiment. The sustainability advisor 320 is configured to retrieve data from the data storage 324 (e.g., the data described with reference to FIGS. 3-7) and cause the optimization system 322 to run optimizations based on the data. The sustainability advisor 320 can be configured to manage a user portal 802 which can provide various pieces of information to a user and receive input from the user.

The user portal 802 can interact with a user by causing the user device 318 to display various user interfaces with information regarding cost improvements, energy reduction improvements, and/or carbon emissions reduction improvements for the building. The information displayed in the user portal 802 can be based on the results of the optimizations run by the optimization system 322. The portal 802 can provide various reports and/or recommendations to the user (e.g., recommended FIMs, recommendations to obtain renewable energy credits (RECs), recommendations to adopt updated control strategies, etc.) for planning the construction, retrofit, and/or operation of a building to meet one or more sustainability goals.

The project advisor 804 can allow a user to review, define, and/or update a project. The project may be to plan sustainability for a particular building and/or building. The advisor 804 can allow a user to set and/or update their sustainability goals. Furthermore, the advisor 804 can allow a user to review their progress in meeting the sustainability goals for their project.

The sustainability planner 806 can provide a plan for meeting sustainability goals for a particular project. The plan generated by the sustainability planner 806 can be based on the optimizations run by the optimization system 322. In some embodiments, the plan generated by the sustainability planner 806 can be a plan for a time horizon, e.g., a thirty year plan, a twenty year plan, etc. The plan can provide the steps for meeting the sustainability goal of the user. The steps can indicate what equipment retrofits should be performed at a present time or at a specified time in the future, how many RECs should be obtained every year or every decade, what control schemes should be adopted, etc. As time passes, the sustainability planner 806 can update the sustainability plan based on new optimizations run by the optimization system 322. This can keep the plan on track to meet a goal as the environment or technology changes and allows the user to meet their goals in more cost effective manners. The planner 806 can generate plans based on sustainability goals 814.

The sustainability tracker 808 can track the progress of the building towards meeting various sustainability goals. The sustainability tracker 808 can, in some embodiments, retrieve operational building data from the data storage 324, energy information from the data storage 324, receipts of REC obtainments from the data storage 324, etc. The sustainability tracker 808 can identify carbon emissions levels for a building at various times in the past and/or at the present. The sustainability tracker 808 can identify a level of renewable energy consumed by the building at times in the past and/or at the present. Furthermore, the sustainability tracker 808 can identify a level of energy consumed by the building at times in the past and/or at the present. The sustainability tracker 808 can provide a user with a historical trend of the sustainability progress of the building towards the one or more sustainability goals.

The user portal 802 includes a sustainability reporter 810. The sustainability reporter 810 can generate various reports indicating sustainability information for the building. The report can indicate a construction plan, retrofit plan, and/or operational plan for a building, e.g., the amounts of energy to consume from various different energy sources, indications of RECs to obtain, indications of equipment retrofits, indications of physical building retrofits (e.g., energy efficient windows, energy efficient insulation, etc.), indications of new equipment installation (e.g., on-site PV cells, on-site wind turbines, etc.). The report generated by the sustainability reporter 810 can indicate how the plan meets one or more sustainability, energy efficiency, and/or financial goals of the user. The sustainability reporter 810 can include a summary report of sustainability planning for the building. The reporter 810 can compile a report based on the data generated by the components 804-808.

The sustainability goals 814 includes the planning data that can be used to run the optimization system 322. The sustainability goals 814 can indicate the various goals and/or expectations of the user. The optimization run by the optimization system 322 can use the sustainability goals 814 as constraints for an optimization, e.g., run an optimization that results in a plan that meets or exceeds the various goals and/or expectations. In some embodiments, the optimization can find a sustainability plan for the building that meets the various sustainability goals of the user at a minimum financial cost.

The timelines 816 can indicate the length of time that the user wants the building to meet various goals (e.g., the goals 818-824). The renewable generation goals 818 indicate a level of energy consumption by the building that the user wants to be generated from renewable energy sources (e.g., solar, wind, etc.). The demand side reduction goals 820 can indicate goals for the demand side systems, e.g., that the demand side systems be energy efficient (e.g., that lighting systems of the building include energy efficient light bulbs). The sustainability goals 822 can be a goal that the operation of the building creates a level of carbon emission, net zero emissions goals, etc. The financial goals 824 can indicate financial goals of the building, e.g., annual energy costs, monthly energy costs, etc.

The optimization parameters 826 include demand side parameters 828 related to the energy demand of a building. The demand side parameters 828 can indicate different types of building equipment retrofits, building equipment maintenance operations, new building equipment installation, building equipment replacement, etc. The demand side parameters 828 can indicate actions that can be taken to modify, change, and/or update the demand side equipment of the building. The parameters 828 can further be linked to renewable energy generation, carbon emissions, energy usage, etc.

The renewable energy generation 830 can indicate parameters for installing renewable energy generation equipment at the building. The parameters 830 can further indicate allocations of energy consumption between external power generation systems, e.g., coal power, hydroelectric power, PV cell systems, wind power systems, etc. The parameters 830 can be linked to various levels of carbon emissions, financial cost, etc.

The parameters 826 include renewable energy credits 832. The renewable energy credits 832 can be various different types of RECs that could be obtained for the building. The parameters can indicate carbon emissions reduction resulting from obtaining RECs and/or financial return from RECs sold by the building. For example, if the building includes on-site renewable energy generation, the building could sell RECs, in some embodiments. Furthermore, the parameters 826 include a virtual power obtainment agreement 834 which can represent an agreed price for renewable energy generation. The parameters can further indicate capital planning 837, e.g., plans for replacing, obtaining, and/or repairing capital of the building (e.g., lighting of the building, conference rooms of the building, audio visual systems, insulation of the building, chillers for the building, AHUs for the building, etc.)

The optimization system 322 can include model services 836. The services 836 can include a marginal cost of carbon 838. The marginal cost of carbon 838 can indicate how much carbon emissions results from the next amount of energy consumed by the building. The marginal cost of carbon can be calculated for external utility services and/or on-site energy generation systems of the building. The marginal cost of carbon can be identified from the various energy information and/or operational decisions of the building. The marginal cost of carbon can, in some embodiments, be based on the optimization parameters 826. The carbon optimizer 840 can run an optimization that identifies decisions for the parameters 826 that results in a particular carbon emissions level. The optimization can be run for a year, five years, ten years into the future, tec. The optimization can be run to slowly reduce the carbon emissions by a particular level every year so that a particular carbon emissions goal is met in the future. The optimization can be run based on the sustainability goals 814 such that the decisions for the parameters 826 are such that the goals 814 are met.

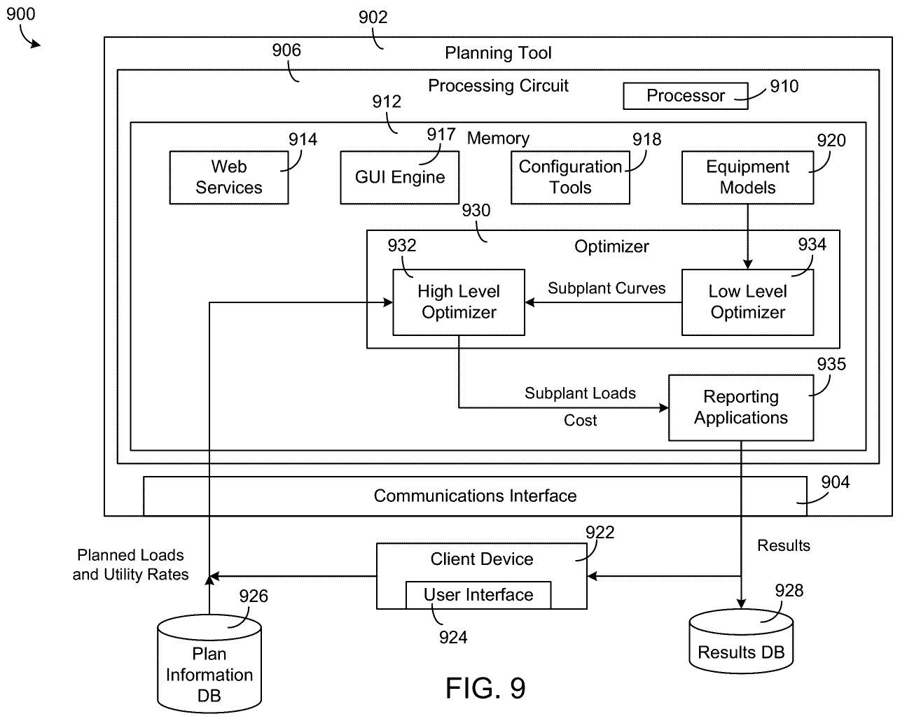

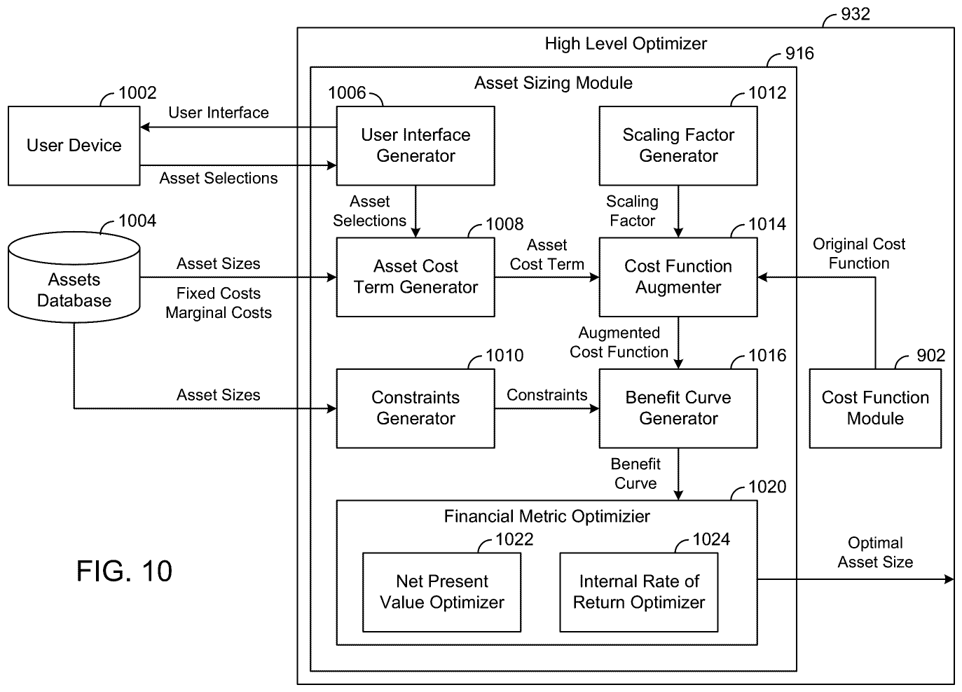

In some embodiments, the optimization run by the optimization system 322 can be based on the optimization described in FIGS. 9 and 10. The optimization can be run with the various linear programming techniques described in FIGS. 9 and 10. Furthermore, the optimization of the optimization system 322 can be based on, and/or can utilize, the techniques described in U.S. patent application Ser. No. 16/518,314 filed Jul. 22, 2019, the entirety of which is incorporated by reference herein.

Referring now to FIG. 9, a block diagram of a planning system 900 is shown, according to an exemplary embodiment. Planning system 900 may be configured to use optimizer 930 as part of a planning tool 902 to simulate the operation of a central plant over a predetermined time period (e.g., a day, a month, a week, a year, etc.) for planning, budgeting, and/or design considerations. The optimizer 930 can optimize for planning a building, e.g., identify construction decisions, retrofit decisions, control plans, etc. The optimizer 930 can run an optimization to minimize carbon emissions, minimize energy consumption, minimize energy cost, maximize renewable energy use, etc. In some embodiments, the optimizer 930 can consider building load in addition to sustainability related features. For example, optimizer 930 may use building loads and utility rates to determine an optimal resource allocation to minimize cost over a simulation period. However, planning tool 902 may not be responsible for real-time control of a building management system or central plant, in some embodiments, while in other embodiments planning tool 902 may provide real-time or near real-time control of a building management system or portions thereof to help achieve the particular goals. In some implementations, planning tool 902 may provide actionable insights or suggestions that, upon approval by a user, are automatically implemented by the building management system or automatically generate changes to a building plan (e.g., pre-construction building plan).

Planning tool 902 can be configured to determine the benefits of investing in a battery asset and the financial metrics associated with the investment. Such financial metrics can include, for example, the internal rate of return (IRR), net present value (NPV), and/or simple payback period (SPP). Planning tool 902 can also assist a user in determining the size of the battery which yields optimal financial metrics such as maximum NPV or a minimum SPP. In some embodiments, planning tool 902 allows a user to specify a battery size and automatically determines the benefits of the battery asset from participating in selected IBDR programs while performing PBDR. In some embodiments, planning tool 902 is configured to determine the battery size that minimizes SPP given the IBDR programs selected and the requirement of performing PBDR. In some embodiments, planning tool 902 is configured to determine the battery size that maximizes NPV given the IBDR programs selected and the requirement of performing PBDR.

In planning tool 902, high level optimizer 932 may receive planned loads and utility rates for the entire simulation period. The planned loads and utility rates may be defined by input received from a user via a client device 922 (e.g., user-defined, user selected, etc.) and/or retrieved from a plan information database 926. High level optimizer 932 uses the planned loads and utility rates in conjunction with subplant curves from low level optimizer 934 to determine an optimal resource allocation (i.e., an optimal dispatch schedule) for a portion of the simulation period. The low level optimizer 934 can receive equipment models 920, in some embodiments.

The portion of the simulation period over which high level optimizer 932 optimizes the resource allocation may be defined by a prediction window ending at a time horizon. With each iteration of the optimization, the prediction window is shifted forward and the portion of the dispatch schedule no longer in the prediction window is accepted (e.g., stored or output as results of the simulation). Load and rate predictions may be predefined for the entire simulation and may not be subject to adjustments in each iteration. However, shifting the prediction window forward in time may introduce additional plan information (e.g., planned loads and/or utility rates) for the newly-added time slice at the end of the prediction window. The new plan information may not have a significant effect on the optimal dispatch schedule since only a small portion of the prediction window changes with each iteration.

In some embodiments, high level optimizer 932 requests all of the subplant curves used in the simulation from low level optimizer 934 at the beginning of the simulation. Since the planned loads and environmental conditions are known for the entire simulation period, high level optimizer 932 may retrieve all of the relevant subplant curves at the beginning of the simulation. In some embodiments, low level optimizer 934 generates functions that map subplant production to equipment level production and resource use when the subplant curves are provided to high level optimizer 932. These subplant to equipment functions may be used to calculate the individual equipment production and resource use (e.g., in a post-processing module) based on the results of the simulation.

Still referring to FIG. 9, planning tool 902 is shown to include a communications interface 904 and a processing circuit 906. Communications interface 904 may include wired or wireless interfaces (e.g., jacks, antennas, transmitters, receivers, transceivers, wire terminals, etc.) for conducting data communications with various systems, devices, or networks. For example, communications interface 904 may include an Ethernet card and port for sending and receiving data via an Ethernet-based communications network and/or a Wi-Fi transceiver for communicating via a wireless communications network. Communications interface 904 may be configured to communicate via local area networks or wide area networks (e.g., the Internet, a building WAN, etc.) and may use a variety of communications protocols (e.g., BACnet, IP, LON, etc.).

Communications interface 904 may be a network interface configured to facilitate electronic data communications between planning tool 902 and various external systems or devices (e.g., client device 922, results database 928, plan information database 926, etc.). For example, planning tool 902 may receive planned loads and utility rates from client device 922 and/or plan information database 926 via communications interface 904. Planning tool 902 may use communications interface 904 to output results of the simulation to client device 922 and/or to store the results in results database 928.

Still referring to FIG. 9, processing circuit 906 is shown to include a processor 910 and memory 912. Processor 910 may be a general purpose or specific purpose processor, an application specific integrated circuit (ASIC), one or more field programmable gate arrays (FPGAs), a group of processing components, or other suitable processing components. Processor 910 may be configured to execute computer code or instructions stored in memory 912 or received from other computer readable media (e.g., CDROM, network storage, a remote server, etc.).

Memory 912 may include one or more devices (e.g., memory units, memory devices, storage devices, etc.) for storing data and/or computer code for completing and/or facilitating the various processes described in the present disclosure. Memory 912 may include random access memory (RAM), read-only memory (ROM), hard drive storage, temporary storage, non-volatile memory, flash memory, optical memory, or any other suitable memory for storing software objects and/or computer instructions. Memory 912 may include database components, object code components, script components, or any other type of information structure for supporting the various activities and information structures described in the present disclosure. Memory 912 may be communicably connected to processor 910 via processing circuit 906 and may include computer code for executing (e.g., by processor 910) one or more processes described herein.

Still referring to FIG. 9, memory 912 is shown to include a GUI engine 917, web services 914, and configuration tools 918. In an exemplary embodiment, GUI engine 917 includes a graphical user interface component configured to provide graphical user interfaces to a user for selecting or defining plan information for the simulation (e.g., planned loads, utility rates, environmental conditions, etc.). Web services 914 may allow a user to interact with planning tool 902 via a web portal and/or from a remote system or device (e.g., an enterprise control application).

Configuration tools 918 can allow a user to define (e.g., via graphical user interfaces, via prompt-driven “wizards,” etc.) various parameters of the simulation such as the number and type of subplants, the devices within each subplant, the subplant curves, device-specific efficiency curves, the duration of the simulation, the duration of the prediction window, the duration of each time step, and/or various other types of plan information related to the simulation. Configuration tools 918 can present user interfaces for building the simulation. The user interfaces may allow users to define simulation parameters graphically. In some embodiments, the user interfaces allow a user to select a pre-stored or pre-constructed simulated plant and/or plan information (e.g., from plan information database 926) and adapt it or enable it for use in the simulation.

Still referring to FIG. 9, memory 912 is shown to include optimizer 930. Optimizer 930 may use the planned loads and utility rates to determine an optimal resource allocation over a prediction window. With each iteration of the optimization process, optimizer 930 may shift the prediction window forward and apply the optimal resource allocation for the portion of the simulation period no longer in the prediction window. Optimizer 930 may use the new plan information at the end of the prediction window to perform the next iteration of the optimization process. Optimizer 930 may output the applied resource allocation to reporting applications 935 for presentation to a client device 922 (e.g., via user interface 924) or storage in results database 928.

Still referring to FIG. 9, memory 912 is shown to include reporting applications 935. Reporting applications 935 may receive the optimized resource allocations from optimizer 930 and, in some embodiments, costs associated with the optimized resource allocations. Reporting applications 935 may include a web-based reporting application with several graphical user interface (GUI) elements (e.g., widgets, dashboard controls, windows, etc.) for displaying key performance indicators (KPI) or other information to users of a GUI. In addition, the GUI elements may summarize relative energy use and intensity across various plants, subplants, or the like. Other GUI elements or reports may be generated and shown based on available data that allow users to assess the results of the simulation. The user interface or report (or underlying data engine) may be configured to aggregate and categorize resource allocation and the costs associated therewith and provide the results to a user via a GUI. The GUI elements may include charts or histograms that allow the user to visually analyze the results of the simulation.

Referring now to FIG. 10, a block diagram illustrating asset sizing module 916 in greater detail is shown, according to an exemplary embodiment. Asset sizing module 916 can be configured to determine the optimal sizes of various assets in a building, group of buildings, or a central plant. As described above, assets can include individual pieces of equipment (e.g., boilers, chillers, heat recovery chillers, steam generators, electrical generators, thermal energy storage tanks, batteries, etc.), groups of equipment, or entire subplants of a central plant. Asset sizes can include a maximum loading of the asset (e.g., maximum power, maximum charge/discharge rate) and/or a maximum capacity of the asset (e.g., maximum stored electric energy, maximum fluid storage, etc.).

In some embodiments, asset sizing module 916 includes a user interface generator 1006. User interface generator 1006 can be configured to generate a user interface for interacting with asset sizing module 916. The user interface may be provided to a user device 1002 (e.g., a computer workstation, a laptop, a tablet, a smartphone, etc.) and presented via a local display of user device 1002. In some embodiments, the user interface prompts a user to select one or more assets or types of assets to be sized. The selected assets can include assets currently in a building or central plant (e.g., existing assets the user is considering upgrading or replacing) or new assets not currently in the building or central plant (e.g., new assets the user is considering obtaining). For example, if the user is considering adding thermal energy storage or electrical energy storage to a building or central plant, the user may select “thermal energy storage” or “battery” from a list of potential assets to size/evaluate. User interface generator 1006 can identify any assets selected via the user interface and provide an indication of the selected assets to asset cost term generator 1008.

### Sustainability Optimizer

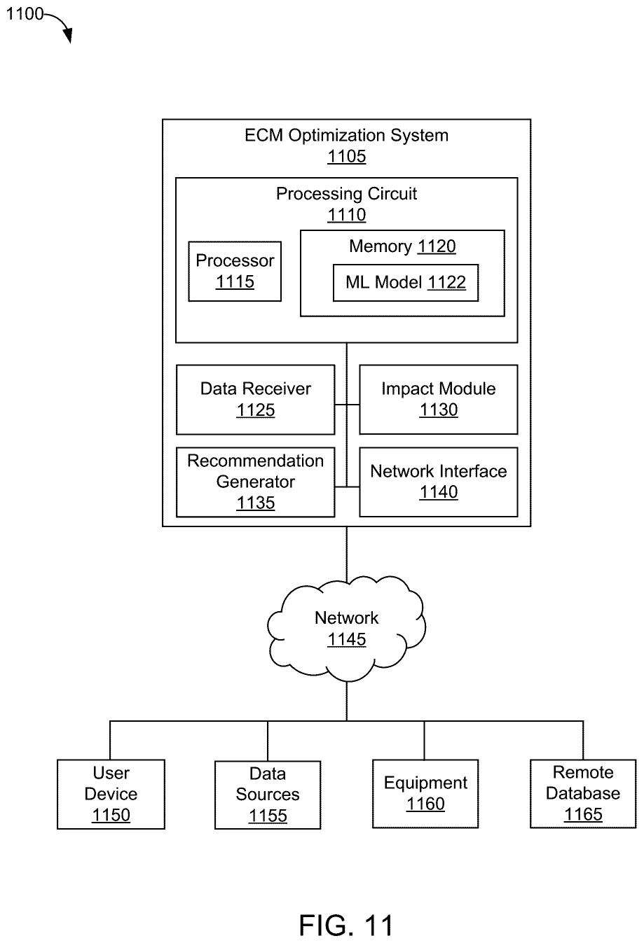

FIG. 11 depicts a block diagram of a system 1100, according to some embodiments. The system 1100 can implement the design optimization and operational planning described herein. Each system and/or component of the system 1100 can include one or more processors, memory, network interfaces, communication interfaces, and/or user interfaces. Memory can store programming logic that, when executed by the processors, controls the operation of the corresponding computing system or device. Memory can also store data in databases. The network interfaces can allow the systems and/or components of the system 1100 to communicate wirelessly. The communication interfaces can include wired and/or wireless communication interfaces and the systems and/or components of the system 1100 can be connected via the communication interfaces. The various components in the system 1100 can be implemented via hardware (e.g., circuitry), software (e.g., executable code), or any combination thereof. Systems, devices, and components in FIG. 11 can be added, deleted, integrated, separated, and/or rearranged.

The system 1100 can include at least one Energy Conservation Measure (ECM) optimization system 1105, at least one network 1145, at least one user device 1150, at least one data source 1155, at least one equipment 1160, and at least one remote database 1165. In some embodiments, at least one component of the system 1100 can be and/or include at least one system, device, and/or component described herein. For example, the user devices 1150 can include the user devices 318. In some embodiments, at least one component of the system 1100 can perform similar functionality to that of at least one system, device, and/or component described herein. For example, the ECM optimization system 1105 can perform similar functionality to that of the energy information retrieval system 304. In some embodiments, the ECM optimization system 1105 can implement the long-term sustainability optimizer described herein. The ECM optimization system 1105 can provide some of the technical solutions described herein.

The network 1145 can be and/or include a local area network (LAN), wide area network (WAN), telephone network (such as the Public Switched Telephone Network (PSTN)), Controller Area Network (CAN), wireless link, intranet, the Internet, a cellular network, and/or combinations thereof.

In some embodiments, an operator of the user devices 1150 can perform various actions and/or access various types of information. The information can be provided over the network 1145 (e.g., the Internet, LAN, WAN, cellular, etc.). The user devices 1150 can perform similar functionality to that of at least one component of the system 1100. For example, the user devices 1150 can perform similar functionality to that of the equipment 1160. The user devices 1150 can include an application to receive information, display information, and/or receive user interactions with content displayed by the user devices 1150.

The user device 1150 can be and/or include at least one of a screen, a monitor, a visual display device, a touchscreen display, a television, a video display, a liquid crystal display (LCD), a light emitting diode (LED) display, a mobile device, a kiosk, a digital terminal, and/or among other possible displays and/or devices. For example, the user device 1150 can be touchscreen displays that include a resistive touchscreen that can receive user input via interactions (e.g., touches) with the touchscreen. In some embodiments, the user device 1150 can be in communication with one another such that the user device 1150 can display a continuous user interface (e.g., a single user interface) across the user device 1150. In some embodiments, the user device 1150 can display, present, and/or otherwise provide a plurality of user interfaces and the plurality of user interfaces can be provided across given user device 1150. The user devices 1150 can also be and/or include at least one of a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.).

The data sources 1155 can be and/or include at least one of the various data sources described herein. For example, the data sources 1155 can include the utility system 402. The data sources 1155 can include lightweight data-driven models that generate the parameters used in the optimization formulation and/or operational planning performed by the system 1100. Data sources 1155 can also include historical data that the data-driven models can be fit to.

The data sources 1155 can be and/or include at least one of the building subsystems 228, the data storage 324, the utility system 402, the building system 618, the plan information database 926, the assets database 1004 or any other possible data source. In some embodiments, the data source 1155 can be a separate component that receives data from at least one of the building subsystems 228, the data storage 324, the utility system 402, the building system 618, the plan information database 926, the assets database 1004 or any other possible data source and then provides the data to the ECM optimization system 1105. The data provided by the data source 1155, to the ECM optimization system 1105, can be or include at least one the facility data 312, the sustainability goals 314, the utility access data 316, or any other possible data described herein.

The equipment 1160 can be and/or include components or pieces of building equipment. Equipment 1160 can include, but is not limited to, for example, a HVAC system, heaters, chillers, boilers, air handling units, sensors, actuators, refrigeration systems, fans, blowers, heat exchangers, energy storage devices, condensers, valves, or various combinations thereof. Equipment 1160 can operate in accordance with various qualitative and quantitative parameters, variables, setpoints, and/or thresholds or other criteria, for example. In some embodiments, equipment 1160 can include or be coupled with one or more controllers for controlling parameters of the equipment 1160, such as to receive commands for controlling operation of the equipment 1160 via one or more wired, wireless, and/or user interfaces of the controller. Equipment 1160 may include or be coupled with components of a building management system (BMS). Equipment 1160 may be associated with emissions information. For example, each piece or component of equipment 1160 may include data relating to an amount of carbon emissions generated with use of the piece of equipment.

The remote database 1165 can be and/or include at least one of a computing device, a remote server, a server bank, a remote device, and/or among other possible computer hardware and/or computer software. For example, the remote database 1165 can include a server bank and the server bank can store, keep, maintain, and/or otherwise hold the various types of information described herein. In some embodiments, the remote database 1165 may house and/or otherwise implement at least one of the various systems, devices, and/or components described herein. For example, the remote database 1165 can house the system 300. In some embodiments, the remote database 1165 can include, store, maintain, and/or otherwise host the ECM optimization system 1105. For example, the ECM optimization system 1105 may be distributed across one or more servers (e.g., the remote database 1165).

The ECM optimization system 1105 can include at least one processing circuit 1110, at least one data receiver 1125, at least one impact module 1130, at least one recommendation generator 1135, and at least one network interface 1140. The processing circuit 1110 can include at least one processor 1115 and at least one memory 1120. The processing circuit 1110 and/or a component thereof (e.g., the processors 1115 and memory 1120) can perform similar functionality to that of the ECM optimization system 1105 and/or a component thereof. For example, memory 1120 can store programming logic that, when executed by the processors 1115, cause the processors 1115 to perform functionality similar to the ECM optimization system 1105 and/or a component thereof.

The network interface 1140 can be and/or include at least one of network communication devices, network interfaces, and/or other possible communication interfaces. The network interface 1140 can be and/or include wired or wireless communications interfaces (e.g., jacks, antennas, transmitters, receivers, transceivers, wire terminals, etc.) for conducting data communications with various systems, devices, and/or components described herein. The network interface 1140 can be direct (e.g., local wired or wireless communications) and/or via a communications network (e.g., the network 1145). For example, the network interface 1140 can include an Ethernet card and port for sending and receiving data via an Ethernet-based communications link or network. The network interface 1140 can also include a Wi-Fi transceiver for communicating via a wireless communications network (e.g., the network 1145). The network interface 1140 can include a power line communications interface. The network interface 1140 can include an Ethernet interface, a USB interface, a serial communications interface, and/or a parallel communications interface.

The network interface 1140 can receive, from a plurality of data sources, operational data corresponding to a building. For example, the network interface 1140 may receive operational data corresponding to the building 10. The operational data may include data that is used by the ECM optimization system 1105 to perform a sustainability optimization. In some embodiments, the operational data may include at least one of emissions information, information about a building (for example, size, capacity, location, etc.), available ECMs for the building (for example, installing a new roof), available binary actions to take (for example, obtaining carbon credits), a cost of implementing an ECM and/or a binary action, the environmental/sustainability impact of implementing each ECM and/or binary action, ECMs, actions, and/or other sustainability measures already enacted in/on the building, and/or building occupant and/or user wants and/or needs. Emission information or emissions impact of each piece of building equipment 1160 may be available. The network interface 1140 can provide the data to at least one component of the system 1100. For example, the network interface 1140 can provide the data to the equipment 1160. In some embodiments, the building system (e.g., BAS 200) can generate emission information without receiving the information from another component or data source. For example, the BAS 200 may determine emissions impacts for one or more components and may generate recommendations and determine points in time to implement the recommendations to adjust emissions impacts.

The data receiver 1125 can receive, from the network interface 1140, the operational data. The data receiver 1125 can extract, from the operational data, a plurality of pieces of operational data. For example, the data receiver 1125 can extract information about ECMs able to be implemented in a building and the cost associated with implementing the ECMs. As another example, the plurality of pieces of operational data may include a cost associated with installing a new roof on a building.

In some embodiments, the network interface 1140 can receive, from the data sources 1155, a continuous and/or semi-continuous stream of information (e.g., operational data). In some embodiments, the data receiver 1125 can extract, in conjunction with the network interface 1140 receiving the information, the plurality of pieces of operational data. For example, the data receiver 1125 can extract the plurality of pieces of operational data as the network interface 1140 is receiving the operational data. In some embodiments, the data receiver 1125 can monitor the pieces of operational data to identify changes to the information. For example, the data receiver 1125 can detect when the cost of implementing an ECM or action changes (e.g., the cost of installing a new roof increases, the cost of retrofitting a cooling system decreases, etc.).

The impact module 1130 can determine, using the operational data, an impact that implementing the ECM will have on the system or building. The determined impact may be an emissions impact. For example, the impact module 1130 can determine that implementing an ECM, such as installing solar panels, will have an emissions impact of reducing natural gas consumption by a certain percentage. Other emissions impacts may include, for example, a net change in overall energy consumption, a net change in gas consumption, a net change in carbon emissions, and a net change in electricity consumption. Emissions impacts may be an impact that affects the entire system or building, while emissions information may be related to a single piece of equipment. For example, emissions information for an energy-efficient chiller may indicate that it operates 30% more efficiently or utilizes 30% less electricity than another type of chiller. The emissions information may be used to determine that, if energy-efficient chillers are installed in a building, the emissions impacts of replacing old chillers with the energy efficient chillers will be that the building's carbon footprint is reduced by 10% each year. The impact module 1130 may utilize, for example, information regarding what ECMs and/or actions are available to be implemented in the building, and/or the cost of implementing ECMs and/or actions, among other information. For example, the impact module 1130 can identify a value by which a total amount of carbon emissions can be reduced for a building if an ECM is implemented and the impact module 1130 can compare the total amount of carbon emissions when the ECM is implemented to a total amount of carbon emissions when the ECM is not implemented to determine by what percentage carbon emissions will decrease.

One or more of the impact module 1130 and/or recommendation generator 1135 may perform the optimization formulation, including a design optimization and operational planning. The processes and methods of the design optimization and operational planning are described in greater detail below, in the section “Sustainability Optimization Formulation.,” For example, in various embodiments, the impact module 1130 performs the design optimization, and the recommendation generator 1135 performs the operational planning of the optimization system.

In various embodiments, the design optimization portion of the optimization formulation includes scheduling design changes and operational changes such that a user or building's sustainability goals are met over a multi-year horizon. In various embodiments, the operational planning portion of the optimization formulation includes planning discretionary curtailment actions to stay on track to meet yearly sustainability goals. Impact module 1130 and/or recommendation generator may each be involved in one or both steps of the optimization formulation. For example, impact module 1130 may be involved with the design optimization step, while the recommendation generator 1135 may be involved with the operational planning step. In various embodiments, the design optimization and operational planning can occur simultaneously or successively.

The impact module 1130 may utilize dynamic programming and/or a mixed integer linear program (MILP) to determine optimal design choices for the sustainability goals of a building.

The impact module 1130 can provide information that the ECM optimization system 1105 uses to perform the sustainability optimization and/or the solutions of the operational planning to the recommendation generator 1135. The recommendation generator 1135 can generate, responsive to identification of the information and/or the optimization formulation, a recommendation of ECMs and/or actions to be implemented and when to take them. The recommendation generator 1135 may generate a recommendation based on predetermined criteria. The predetermined criteria may include, for example, user preferences relating to when an ECM and/or action should be implemented.

In some embodiments, the predetermined criteria may be received by the data receiver 1125 and/or come from the data source 1155. The recommendation can be displayed by the equipment 1160. For example, the equipment 1160 can provide, display, and/or otherwise produce a plurality of user interfaces and the plurality of user interfaces can include the recommendation. In some embodiments, the recommendation can be provided and/or otherwise visible within the command center described herein. The recommendation may also be displayed on the user device 1150. Features of the user interface(s) displaying the recommendation made by the recommendation generator 1135 are described herein in the section “User Interface.”

In some embodiments, the data receiver 1125 may receive emission information. For example, the data receiver 1225 may receive emission information corresponding to the building 10. In some embodiments, the data receiver 1125 may receive the emission information from one or more data sources. For example, the data receiver 1125 may receive the emission information from the data sources 1155. In some embodiments, the emission information may be associated with one or more pieces of building equipment. For example, the emission information may be associated with the equipment 1160. In some embodiments, the emission information may be associated with or related to the building structure. For example, windows of a building may not be sealed tightly, causing air to escape, which may make the building less efficient. To continue this example, the emission information may reflect and/or indicate that the windows are making the building less efficient. In some embodiments, emission information may be related to building occupancy. For example, emissions information may indicate that when a building is at or near maximum occupancy, the building operates less efficiently than when the building is at a lower capacity.

In some embodiments, the data receiver 1125 may provide the emission information to one or more components of the ECM optimization system 1105. For example, the data receiver 1125 may provide the emission information to the impact module 1130. In some embodiments, the data receiver 1125 may continuously and/or semi-continuously provide the emission information.

In some embodiments, the impact module 1130 may receive information from the data receiver 1125. For example, the impact module 1130 may receive the emission information from the data receiver 1125. In some embodiments, the impact module 1130 may determine one or more emission impacts. For example, the impact module 1130 may determine emission impacts for the equipment 1160. In some embodiments, emission impacts may refer to and/or include a contribution (e.g., a percentage, a portion, a value, etc.) that a given piece of equipment had on an emission score for a building. For example, a building may have an emission score of X. To continue this example, an emission impact for a piece of equipment may be determined based on a contribution that the piece of equipment had on the emission score of X. In some embodiments, the impact module 1130 may provide the emission impacts to the recommendation generator 1135. In various embodiments, an emission impact may refer to and/or include a numerical value corresponding to a change in building emissions due to the implementation of an ECM. For example, an emission impact may be that installing solar panels will reduce carbon emissions for a building by 10%. Emissions impacts may also refer to and/or include an overall change for a building caused by the implementation of one or more ECMs.

In some embodiments, the recommendation generator 1135 may receive the emission impacts from the impact module 1130. For example, the recommendation generator 1135 may receive the emission impacts responsive to the impact module 1130 determining the emission impacts. In some embodiments, the recommendation generator 1135 may generate one or more recommendations. For example, the recommendation generator 1135 may generate recommendations that adjust, change, and/or modify an emission score for a building. As another example, the recommendation generator 1135 may generate recommendation that may result in lower carbon emissions for a building.

In some embodiments, one or more recommendations may be for an entire building and/or specific locations within the building. For example, a recommendation may be generated to lower emissions impacts on a single floor of a building. In various embodiments, recommendations may be design choices. Design recommendations may be structural, such as replacing or upgrading windows, building insulation, or other structural elements of the building. In various embodiments, the recommendations may include changes, modifications, variations, and/or adjustments for spatial configuration and/or spatial reconfiguration. For example, the recommendation generator 1135 may generate recommendations to reconfigure the furniture in a room to be optimally efficient. As another example, the recommendation generator 1135 may generate recommendations for layout and/or configuration for a multi-use and/or reconfigurable room. In various embodiments, the recommendations may be an operational action to take. For example, the recommendation generator 1135 may generate recommendations to shut down one or more portions of a building. For example, a portion of the building may experience significant sun exposure. A recommendation may be to shut down (e.g., close, decommission, locked, etc.) the portion with significant sun exposure and concentrate occupancy in other parts of the building during warm months. The recommendations may also include keeping the portion with significant sun exposure open in cooler months. Operational action recommendations may also include indirect actions, such as obtaining carbon credits/offsets.

As another example, the recommendation generator 1135 may simulate, for various spatial configurations, control strategies and/or equipment control to identify one or more spatial configurations that may lower emissions for a given room. For example, a room may have a first spatial configuration and a second configuration. To continue this example, the recommendation generator 1135 may simulate control strategies for the first spatial configuration and the second configuration. In some embodiments, the recommendation generator 1135 may recommend the first spatial configuration as the default spatial configuration based on the first spatial configuration having a lower energy consumption.

In some embodiments, the recommendations may refer to and/or include at least one of Energy Conservation Measures (ECMs), Facility Improvement Measures (FIMs), and/or building retrofits. For example, a first recommendation may include replacing a boiler for the building 10 (e.g., a FIM). As another example, a second recommendation may include installing solar panels. In some embodiments, the recommendation generator 1135 may generate recommendations using one or more techniques and/or processes described in U.S. patent application Ser. No. 18/141,088 filed on Apr. 28, 2023, and/or U.S. patent application Ser. No. 18/098,003 filed on Jan. 17, 2023, the entirety of each application is incorporated by reference herein.

In some embodiments, the recommendation generator 1135 may simulate implementation of at least one recommendation of the plurality of recommendations generated by the recommendation generator 1135 at a plurality of points in time. In some embodiments, a simulation model may be included in the optimization problem as one or more constraints to the problem, and the ECM optimization system 1105 may apply an algorithm to determine an optimal solution to the problem (e.g., an optimization problem is solved to determine one or more points in time to implement ECMs). Various configurations of implemented recommendations may be simulated. For example, different rooms of a building may be simulated according to different configurations depending on, for example, occupation of the rooms, layouts of the rooms, available ECMs for the rooms, etc.

In various embodiments, the plurality of parameters may be provided as one or more vectors that are input into the model. In various embodiments, the plurality of parameters may adjust and/or define weights for a model. For example, a first parameter of the plurality of parameters may be weighted more heavily as an input to the model than a second parameter of the plurality of parameters. Additional examples of inputting one or more parameters into a model are described herein. Parameters may be, for example, any of the optimization parameters 826 described with respect to FIG. 8 and/or ECMs to be implemented within the building.

In some embodiments, recommendation generator 1135 may simulate implementation of one or more recommendations. For example, the recommendation generator 1135 may use the ML model 1122 to simulate implementation of recommendations at one or more points in time. In some embodiments, the recommendation generator 1135 may simulate implementation of one or more recommendations without the use of the model. For example, a user may present a prompt or query to an artificial intelligence system asking to simulate the implementation over a given time period.

In some embodiments, the recommendation generator 1135 may determine one or more points in time to implement recommendations. For example, the recommendation generator 1135 may determine a first point in time of the plurality of points in time to implement a first recommendation. As another example, the recommendation generator 1135 may determine a second point in time to implement a second recommendation. In some embodiments, the recommendation generator 1135 may perform at least one of the various optimization techniques described herein to determine the points in time.

In some embodiments, the recommendation generator 1135 may determine the points in time based on given impacts that implementation of recommendations, at the points in time, would have on an emission score for a building. The recommendation generator may determine the points responsive to the simulation of the implementation of the at least one recommendation. For example, the recommendation generator 1135 may determine a first point in time to implement a first recommendation based on a resulting impact on carbon emissions for a building. In some embodiments, implementation of the at least one recommendation of the plurality of recommendations may include controlling one or more pieces of building equipment of the plurality of pieces of building equipment, or otherwise retrofitting or replacing one or more pieces of building equipment. Stated otherwise, if implementation of a given recommendation, at a first point in time, would have a greater impact on carbon emission for a building than implementation of the given recommendation at a second point in time, the recommendation generator 1135 may determine to implement the given recommendation at the first point in time.

In some embodiments, the ECM optimization system 1105 may generate one or more user interfaces. For example, the ECM optimization system 1105 may generate Graphical User Interfaces (GUIs). In some embodiments, the ECM optimization system 1105 may generate the user interfaces responsive to the impact module 1130 determining emission impacts. In some embodiments, the ECM optimization system 1105 may generate user interfaces that include information generated by one or more components of the system 1100. For example, the ECM optimization system 1105 may generate user interfaces that include the emission information provided by the data sources 1155.

In some embodiments, the ECM optimization system 1105 may generate user interfaces that include one or more graphical representations. For example, the ECM optimization system 1105 may generate user interfaces that include a graphical representation to indicate the recommendations generated by the recommendation generator 1135. For example, the ECM optimization system 1105 may generate a user interface that includes at least one of text boxes, tabs, windows, icons, etc. that indicate the recommendations. In some embodiments, the ECM optimization system 1105 may generate user interfaces that include one or more elements. For example, the user interfaces may include at least one or more scrolls, buttons, click boxes, cursors, slide rolls, and/or arrows. In some embodiments, the elements may indicate the points in time determined by the recommendation generator 1135.

In some embodiments, the user interfaces generated by the ECM optimization system 1105 may be displayed, for example, by the ECM optimization system 1105 or a component of the BMS. In some embodiments, the network interface 1140 may transmit one or more signals to the components and/or devices of the system 1100. For example, the network interface 1140 may transmit signals to the user device 1150. In some embodiments, the network interface 1140 may transmit signals to cause one or more devices to display at least one user interface. For example, the network interface 1140 may transmit, to the user device 1150, one or more signals that causes the user device 1150 to display the user interfaces generated by the ECM optimization system 1105.

While some examples described herein have discussed the ECM optimization system 1105 generating recommendations and transmitting signals to devices for display, at least one of the computing steps described herein may be performed by an edge device or at the edge. For example, the building 10 may include an edge device that can perform operations similar to those performed by the ECM optimization system 1105. As another example, the user device 1150 may store an application having instructions that causes the user device 1150 to perform operations similar to those performed by the ECM optimization system 1105. In some embodiments, a first computing device may perform one or more computing steps similar to that of the ECM optimization system 1105 and a second computing device may receive one or more signals for display. In other embodiments, the first computing device may perform the one or more computing steps and display information associated with the computing steps.

In some embodiments, the recommendation generator 1135 may use predetermined criteria. The predetermined criteria may include a plurality of parameters. For example, the plurality of parameters may include budget constraints. In various embodiments, the plurality of parameters may correspond to one or more ECMs associated with at least one recommendation. The ECM optimization system 1105 may receive predetermined criteria from user inputs. The ECM optimization system may receive the user inputs from a user device 1150.

In some embodiments, the recommendation generator 1135 may use the predetermined criteria to determine the first point in time to implement one or more recommendations. The recommendation may be a recommendation generated by the recommendation generator 1135. In some embodiments, the recommendation generator 1135 may use a model. For example, the recommendation generator 1135 may input the plurality of parameters into a model determine the first point in time to implement the at least one recommendation. In various embodiments, the model generated by the recommendation generator 1135 may simulate the implementation of the at least one recommendation at a plurality of points in time.

In some embodiments, the recommendation generator 1135 may determine the first point in time to implement the at least one recommendation generated by the recommendation generator 1135. In various embodiments, a predetermined level of emission performance may be generated for the building by the impact module 1130. In some embodiments, the predetermined level of emission performance may be generated by the recommendation generator 1135. For example, a predetermined level of emission performance may be generated for the building by the recommendation generator 1135 by identifying one or more points in time of the plurality of points in time predicted to correspond to the predetermined level of emission performance. Identifying the one or more points in time may be responsive to the simulation performed by the recommendation generator 1135.

In some embodiments, the recommendation generator 1135 may determine the first point in time to implement the at least one recommendation. The recommendation generator 1135 may determine the first point in time based on an amount of time it takes to obtain the predetermined level of emission performance for the building.

In some embodiments, the user interface generated by the ECM optimization system 1105 may include one or more selectable elements. The selectable elements may be associated with the plurality of recommendations generated by the recommendation generator 1135. For example, the selectable elements may include a month in which the recommendation will be implemented. The user device 1150 may communicate an indication of a selection of a first selectable element. The processing circuit 1110 may receive the indication of the selection. In various embodiments, the first selectable element may be associated with a first recommendation of a plurality of recommendations generated by the recommendation generator 1135.

In some embodiments, the processing circuit 1110 may identify a modification. The modification may be related to a request to change implementation of the first recommendation made by recommendation generator 1135. The modification may be, for example, to change the implementation of the first recommendation from a second point in time to a third point in time. For example, the modification may be to change the implementation of the recommendation from the month of June to the month of July.

In some embodiments, the network interface 1140 may transmit one or more second signals to the components and/or devices of the system 1100. For example, the network interface 1140 may transmit signals to the user device 1150. In some embodiments, the network interface 1140 may transmit second signals to cause one or more devices to display at least one user interface. For example, the network interface 1140 may transmit, to the user device 1150, one or more second signals that causes the user device 1150 to update the user interfaces generated by the ECM optimization system 1105. The update may reflect implementation of the first recommendation at the third point in time.

In some embodiments, the ECM optimization system 1105 may input one or more parameters into a model. The model may be generated by the recommendation generator 1135. The parameters may be associated with implementation of the first recommendation at the third point in time. The parameters may be input into a model generated by the recommendation generator 1135.

In some embodiments, the recommendation generator 1135 may utilize the model to determine an adjustment to an emission impact of the emission impacts determined by impact module 1130. The adjustment to the emission impact may be for a first piece of building equipment 1160 of the plurality of pieces of building equipment 1160. The determination of the adjustment may be based on implementation of the first recommendation by the recommendation generator 1135 at the third point in time.

In some embodiments, the network interface 1140 may transmit one or more third signals to the components and/or devices of the system 1100. For example, the network interface 1140 may transmit signals to the user device 1150. In some embodiments, the network interface 1140 may transmit third signals to cause one or more devices to display at least one user interface. For example, the network interface 1140 may transmit, to the user device 1150, one or more third signals that causes the user device 1150 to update the user interfaces generated by the ECM optimization system 1105. The update may reflect the adjustment to the emission impact.

In some embodiments, the ECM optimization system 1105 may input one or more parameters into a model. The model may be generated by the recommendation generator 1135. In some embodiments, the parameters may be associated with implementation of the first recommendation at the third point in time. For example, the parameters associated with implementation of the first recommendation at the third point in time may be input into a model generated by the recommendation generator 1135.

In some embodiments, the model generated by recommendation generator 1135 may be used to identify one or more second recommendations of the plurality of recommendations. The one or more second recommendation may be used to modify implementation from one or more points in time. For example, the recommendation may be used to modify implementation from one or more fourth points in time to one or more fifth points in time. The modification may be based on the implementation of the first recommendation at the third point in time.

In some embodiments, the network interface 1140 may transmit one or more third signals to the components and/or devices of the system 1100. For example, the network interface 1140 may transmit signals to the user device 1150. In some embodiments, the network interface 1140 may transmit third signals to cause one or more devices to display at least one user interface. For example, the network interface 1140 may transmit, to the user device 1150, one or more third signals that causes the user device 1150 to update the user interfaces generated by the ECM optimization system 1105. The update may reflect implementation of the second recommendation at the fifth point in time.

In some embodiments, the recommendation generator 1135 may input the plurality of parameters into the model to simulate implementation of the at least one recommendation of the plurality of recommendations. The plurality of parameters may correspond to the plurality of points in time. In some embodiments, the plurality of parameters put into the model at the recommendation generator 1135 may correspond to one or more Energy Conservation Measures associated with the at least one recommendation of the plurality of recommendations.

In some embodiments, the user interface generated by the ECM optimization system 1105 may include plurality of selectable elements. The selectable elements may be associated with the plurality of recommendations generated by the recommendation generator 1135. The ECM optimization system 1105 may receive an indication of a selection of a first selectable element of the plurality of selectable elements. The ECM optimization system 1105 may receive the indication of the selection from the user device 1150. The first selectable element may be associated with a first recommendation of the plurality of recommendations.

In some embodiments, the ECM optimization system 1105 may determine that the selection defines a second point in time to implement the first recommendation. The determination bay be responsive to receipt of the indication of the selection.

In some embodiments, the network interface 1140 may transmit one or more second signals to the components and/or devices of the system 1100. For example, the network interface 1140 may transmit second signals to the user device 1150. In some embodiments, the network interface 1140 may transmit second signals to cause one or more devices to update at least one user interface. For example, the network interface 1140 may transmit, to the user device 1150, one or more second signals that causes the user device 1150 to update the user interface to reflect implementation of the first recommendation at the second point in time.

In some embodiments, the ECM optimization system 1105 may modify one or more parameters. The one or more parameters may be associated with simulating implementation of the first recommendation. Simulating implementation may be performed by the recommendation generator 1135. The simulation implementation may be performed to prevent an adjustment to the second point in time without receipt of a subsequent selection. The modification may be based on the selection defining the second point in time.

In some embodiments, the network interface 1140 may transmit one or more third signals to the components and/or devices of the system 1100. In some embodiments, the network interface 1140 may transmit one or more third signals to implement the first recommendation. In some embodiments, the network interface 1140 may transmit one or more third signals to the recommendation generator 1135. In various embodiments, the network interface 1140 may transmit the one or more third signals responsive to the detection of the second point in time.

In some embodiments, the ECM optimization system 1105 may detect a change to an emission impact of the emission impacts to a first piece of building equipment of the plurality of pieces of building equipment. The detection of the change may be responsive to implementation of the first recommendation.

In some embodiments, the network interface 1140 may transmit one or more fourth signals to the components and/or devices of the system 1100. For example, the network interface 1140 may transmit fourth signals to the user device 1150. In some embodiments, the network interface 1140 may transmit fourth signals to cause one or more devices to update at least one user interface. For example, the network interface 1140 may transmit, to the user device 1150, one or more fourth signals that causes the user device 1150 to update the user interface to reflect the change to the emission impact.

In some embodiments, the user interface generated by the ECM optimization system 1105 may include a plurality of selectable elements. The plurality of selectable elements may be associated with the plurality of recommendations generated by the recommendation generator 1135. In various embodiments, interactions with one or more selectable elements of the plurality of selectable elements may adjust one or more parameters associated with implementation of one or more recommendations of the plurality of recommendations.

In some embodiments, the ECM optimization system 1105 may receive an indication of a selection of a first selectable element of the plurality of selectable elements. The indication of the selection may be received from the user device 1150. The first selectable element may be associated with a first recommendation of the plurality of recommendations.

In some embodiments, the ECM optimization system 1105 may adjust one or more parameters associated with the first recommendation. The adjustment may be responsive to the receipt of the indication of the selection.

In some embodiments, the ECM optimization system 1105 may determine one or more subsequent changes to one or more points in time to implement one or more recommendations of the plurality of recommendations. The subsequent changes may be made to consider the adjustment to the one or more parameters associated with the first recommendation. The determination may be responsive to adjusting the one or more parameters.

In some embodiments, implementation of the at least one recommendation by the ECM optimization system 1105 results in an adjustment of an emission score for the building from a first value to a second value. The adjustment of the emission score may be determined by the impact module 1130.

In some embodiments, the adjustment of the emission score for the building includes a reduction in carbon emissions for the building. The adjustment of the emission score may be determined by the impact module 1130.

In some embodiments, the adjustment of the emission score for the building includes a reduction in energy consumption for the building. The adjustment of the emission score may be determined by the impact module 1130.

### Sustainability Optimization Formulation

The ECM optimization system 1105 of the system 1100 is described in greater detail herein. One or more of the elements of system 1100 may utilize the processes and/or methods of the system 1100 described herein. For example, impact module 1130 may perform one or more of the steps of the processes and/or methods described herein.

An optimization formulation can be applied to both design and operation of a building. The formulation can include timing decisions for relevant design changes and operational actions, which can lead to successful implementation. The general form of the design optimization problem can be reformulated in state-space to be amenable to solution by dynamic programming and usage in closed loop. A reduced form of the problem can be suitable for operational planning (i.e., after design decisions have been fixed). Various solution methods can be performed and are described herein.

### General Design Optimization Problem

The optimization problem covers both design decisions, which can be persistent, and operational actions, which can take effect for a current time period. For example, installing a new roof on a building can be a design decision for a building, since a new roof can persist, while obtaining a carbon credit can be an operational action, since it may take effect for a current time period. Sustainability goals for the building can be represented as upper bounds on consumption of various resources over given time windows. A resource can be defined, for example, for net electricity obtainment, total energy consumption, net carbon emissions, implementation cost, or any other quantities of interest. Decisions can be binary decisions associated with making design changes to the building (i.e., implementing an energy conservation measure (ECM) or retrofitting part of the building) or implementing operational measures (e.g., adjusting building thermostat setpoints or obtaining emissions credits). This formulation is referred to herein as the “design optimization” problem.

Sets can be defined to determine a solution for the design optimization problem. t∈T can be defined as discrete time points where decisions are considered. w∈W can be defined as time windows over which resource consumption constraints are enforced. In various embodiments, the time windows can be single-period. In various embodiments, the time windows can be multi-period. t∈T_{w}⊂T can be defined as a subset of time points included within the window w. r∈R can be defined as resources subject to consumption constraints. In various embodiments, resources can include, for example, both sustainability metrics associated with goals, as well as other considerations such as, for example, implementation cost subject to budgets. x∈X can be defined as available design changes to consider. u∈U can be defined as available operational actions to consider.

Design changes and operational actions can be referred to as “decisions,” and can reflect primary choices being made by the optimization problem. Based on the sets defined above, the optimization problem can consider the following decision variables. Xₓₜ can be defined as whether design change x∈X has been implemented at time t∈T. Xₓₜ can be implicitly binary. Uᵤₜ can be defined as whether operational action u∈U is taken at time t∈T. Uᵤₜ can be binary. Vₓₜ can be defined as whether or not to implement design change x∈X at time t∈T. Vₓₜ can be binary. Yᵣₜ can be defined as a total consumption of resource r∈R during time period t∈T. Yᵣₜ can be continuous.

In various embodiments, X*ₜ represents values of all {Xₓₜ: x∈X}, which can be referred to as the “design state” of the system. Similarly, in various embodiments, U*ₜ and V*ₜ can represent all operational actions and current design decisions {Uᵤₜ: u∈U} and {Vₓₜ: x∈X}. The following parameters are used. αₜ (X*ₜ, U*ₜ, V*ₜ) can be a cost of taking operational actions U*ₜ and implementing design decisions V*ₜ based on design state X*ₜ at time period t. ρᵣₜ(X*ₜ, U*ₜ, V*ₜ) can be a consumption of resource r∈R at time t∈T given a current system design state X*ₜ, operational actions U*ₜ, and design changes V*ₜ. β_{rw} can be an upper bound on consumption of resource r∈R over time window w∈W. For the first two functions (i.e., αₜ(X*ₜ, U*ₜ, V*ₜ) and ρᵣₜ (X*ₜ, U*ₜ, V*ₜ)), the mathematical form can be unspecified.

In various embodiments, a goal of the optimization problem may be to decide values at each timestep for the decisions Uᵤₜ and Vₓₜ such that a resulting trajectory of design states Xₓₜ and resource consumption Yᵣₜ satisfy the constraints at a lowest possible cost. Inherent dynamics of the system are an evolution of the system design states Xₓₜ, which evolve as follows:

$${X}_{xt} = {X}_{x ( t - 1 )} + {V}_{xt} , x ∈ X , t ∈ T \qquad ( 1 )$$

At a first time point t=1 of equation (1), variable Xₓ₍ₜ₋₁₎ can be replaced by a corresponding parameter giving the starting design state of the system. In various embodiments, all design changes can be independent and persist through an end of a time horizon. Binary restrictions on Xₓₜ and Vₓₜ may implicitly enforce the independency and persistence of the design changes. However, additional constraints could be added to cover further restrictions. For example, standard clique constraints for mutually exclusive options or implication constraints for sequence restrictions can be added.

Resource consumption can be calculated as follows based on the design state of the system:

$${Y}_{rt} = {ρ}_{rt} ( {X}_{* t} , {U}_{* t} , {V}_{* t} ) , r ∈ R , t ∈ T \qquad ( 2 )$$

The relationship shown in (2) gives resource consumption resulting from a new system design state X*ₜ and other chosen operational actions U*ₜ. In some embodiments, the

$${\sum }_{t ∈ {T}_{w}} {Y}_{rt} \leq {β}_{rw} , r ∈ R , w ∈ W \qquad ( 3 )$$

relationship can account for whether or not the system design state has been updated via V*ₜ. From the values, budget constraints can be enforced on each window:

In various embodiments, the constraints can be softened. In various embodiments, the constraints can be softened, for example, with a linear penalty. For example, budgets β_{wt} may be too restrictive. The optimizer can find a solution as close to feasible as possible using softened constraints.

In various embodiments, an objective function of the optimization problem can be to minimize a total cost associated with all actions, design and otherwise. A formulation to achieve the objective function can be modeled as:

$$min {\sum }_{t ∈ T} {α}_{t} ( {X}_{* t} , {U}_{* t} , {V}_{* t} ) \qquad ( 4 )$$

In various embodiments, the formulation can be agnostic to a particular functional form of αₜ(⋅). However, in various embodiments, it can be a linear sum with fixed costs associated with each decision. The cost terms can be discounted with a given per-timestep discount factor.

The overall design optimization problem is thus as follows:

$$minimize ( 4 ) over {X}_{xt} , {U}_{ut} , {V}_{xt} , {Y}_{rt} subject to ( 1 ) , ( 2 ) , ( 3 ) \qquad ( 5 )$$

The resulting solution can indicate when to take each design decision (i.e., via Vₓₜ) and operational decision (i.e., via Uₓₜ). Values of the variables uniquely specify the remaining variables, which may mean slightly modified parameters can be used for optimization, and performance can be recalculated in terms of the original parameter values.

### State-Space Reformulation

Equation (5) is a standard mathematical programming problem. However, the problem can be reformulated so that a state-space form of the problem is clear, and the problem can be solved in closed loop. Specifically, the problem can be written so that the objective function can be written as a sum over terms unique to each time point and that any constraints involve only variables from a single time point.

To arrive at a valid state-space formulation, additional auxiliary variables can be added to capture any prior “state” of the system that may be relevant for constraints. Values of past decision variables can be “lifted” (i.e., add dummy copies) as far back in the horizon as needed for the constraints. However, this property can cause the number of unique states to grow exponentially with the length of the time windows. Therefore, the property is unfavorable to solution via dynamic programming. The constraints (3) are a restriction on the sum of resource consumptions over time and auxiliary variables Z_{rwt} can be added to keep a running tally of the resource consumptions. Z**ₜ represents the collection of values for all r∈R and w∈W. The budget constraints can then be enforced as simple bounds on the variables at specific time points.

To specify the dynamics of the new state variables, a new parameter can be defined:

$${σ}_{wt} := \{ \begin{matrix}1 & if t ∈ {T}_{w} \\ 0 & else\end{matrix}$$

σ_{wt} can give a binary mask or membership of time points in windows. The Z_{rwt} variables evolve as follows with an inclusion of σ_{wt}:

$${Z}_{rwt} = {Z}_{rw ( t - 1 )} + {σ}_{tw} {Y}_{rt} \qquad ( 6 )$$

The updated formula can indicate that Z_{rwt} gives the cumulative value of Yᵣₜ so far within this window. Similarly to Xₓ₀, starting values Z_{rw0} can be assumed to be given as parameters. Budget constraints (3) can be enforced as simple bounds with new parameter

$${Z}_{rwt} \leq {\hat{β}}_{rwt} \\ {\hat{β}}_{rwt} := \{ \begin{matrix}{β}_{rw} & if t = {max}_{t ′ ∈ {T}_{w}} {t}^{′} \\ ∞ & else\end{matrix} \qquad ( 7 )$$

The bound may be binding only at a final time point within the window.

With reformulations, the modified optimization formulation is:

$$minimize ( 4 ) over {X}_{xt} , {U}_{ut} , {V}_{xt} , {Y}_{rt} , {Z}_{rwt} subject to ( 1 ) , ( 2 ) , ( 6 ) , ( 7 ) \qquad ( 8 )$$

For a given value of t∈T, the values of Xₓₜ and Z_{rwt} can represent the state of the system in the state-space sense, while decisions Uᵤₜ and Vₓₜ can represent the inputs. The recommendation generator 1135 may input the decisions Uᵤₜ and Vₓₜ into the model. The formulation may be amenable to solution via dynamic programming, which can be applied in closed loop.

### Simplified Operational Planning Problem

In various embodiments, if a given design has been implemented, it may be necessary to operate a building efficiently in order to meet established goals. In various embodiments, goals may not be achieved due to inherent uncertainty associated with future resource consumption. For example, if consumption is higher than expected, operation may need to be adjusted to make up for the gap (e.g., by curtailing discretionary loads or obtaining credits from the market). For this purpose, an optimization problem similar to (8) can be used, but with design decisions removed. The reduced formulation can be referred to as the “operational planning” problem.

The reduced formulation can be arrived at by removing Xₓₜ and associated Vₓₜ decision variables. In various embodiments, a future trajectory is known (for example, per results of previous design optimization). An effect can then be captured via a time dependence of relevant functions αₜ(⋅) and ρᵣₜ(⋅). The state-space formulation can be retained and the objective function and constraints are as follows:

$$min {\sum }_{t ∈ T} {α}_{t} ( {U}_{* t} ) \qquad ( 9 )$$

$$\begin{matrix}{Y}_{rt} = {ρ}_{rt} ( {U}_{* t} ) & r ∈ R , t ∈ T\end{matrix} \qquad ( 10 )$$

$$\begin{matrix}{Z}_{rwt} = {Z}_{rw ( t - 1 )} + {σ}_{tw} {Y}_{rt} & r ∈ R , w ∈ W , t ∈ T\end{matrix} \qquad ( 11 )$$

$$\begin{matrix}{Z}_{rwt} \leq {\hat{β}}_{rwt} & r ∈ R , w ∈ W , t ∈ T\end{matrix} \qquad ( 12 )$$

As in the design formulation described above, budget constraints (12) can be implemented as soft constraints. In some embodiments, soft budget constraints can be implemented with a large violation penalty so that there always exists a feasible solution. The full optimization problem is thus

$$minimize ( 9 ) over {U}_{ut} , {Y}_{rt} , {Z}_{rwt} subject to ( 10 ) , ( 11 ) , ( 12 ) \qquad ( 13 )$$

When solved in closed-loop, a starting value of each Z_{rwt} for t=0 can be given. After implementing initial decisions Uᵤₜ for t=1, the states can be updated, along with any forecasts associated with resource consumption ρᵣₜ(⋅) and budgets \hat{β}_{rwt}.

In operational planning problem (13), a timestep (i.e., the length of time spanned by each time element t∈T) can be shorter compared to the full design problem (8). For example, if the design problem made decisions on a quarterly monthly basis, the operational planning problem will make decisions on a weekly or monthly basis. A faster timescale can allow the system to react more quickly to updated current or predicted consumption. Net-zero metrics may be subject to uncertainty in both consumption, which can be adjusted via operational actions and generation, which can be unaffected by optimization decisions, making the faster timescale important. Along with the change, a total horizon of the operational planning problem can cover a shorter time period. In various embodiments, the total horizon may cover to an end of a last time window containing a current time. For example, in a typical case of annual goals, the operational planning horizon would extend to the end of the current year and have a shrinking horizon in closed-loop. Other variations could be possible in various embodiments.

### Solution Methods

Both the design optimization problem (8) and the operational planning problem (13) can be mixed-integer nonlinear programming (MINLP) problems. In various embodiments, decision variables are both continuous and discrete, while constraints and objective function are nonlinear. Key behavior can be captured by a convex form of the models, and standard strategies for convex MINLPs can be applied. Furthermore, if some degree of approximation is acceptable, a fully linear formulation can be possible, thus allowing solution as a mixed-integer linear program (MILP). However, in various embodiments, solution of both problems via dynamic programming can be performed to achieve, for example, generality, or other favorable properties.

In order to apply dynamic programming, a set of states Xₜ and inputs Uₜ at each time point can be defined. The states can be values of (X*ₜ, Z**ₜ), while inputs can be values of (U*ₜ, V*ₜ). For example, in the case of the discrete variables X*ₜ, U*ₜ, and V*ₜ, the set of all possible values is clear. The Z**ₜ are continuous and can require special handling in one of two ways. A first option is to force the values of resource consumption ρᵣₜ(⋅) to be quantized. With this restriction, there can exist a finite number of possible values for each Z_{rwt}, and the set of feasible states Xₜ can include all those values. In this option, the dynamic programming solution is exact for the quantized problem, but the quantization process may introduce some error (i.e., slight constraint violation and suboptimality). A second option is to allow Z**ₜ to be fully continuous but to evaluate solutions at a finite number of grid points. In this option, the dynamic programming solution is approximate, as values for Z**ₜ in between grid points have to be estimated via interpolation instead of looked up exactly, but the resulting solution can be more faithful to the original problem. In some embodiments, the first option is more useful for purposes. In some embodiments, the second option is more useful for purposes.

An algorithm can be applied to determine the optimal solution for the design optimization problem (8) when the sets of states and inputs have been defined. Inputs to the algorithm can include time horizon T:=|T|, set of feasible states Xₜ, set of feasible inputs Uₜ, initial state X*₀, Z**₀, and all problem parameters. Outputs of the algorithm can include optimal decisions U*ₜ, and V*ₜ. The algorithm can include lookups of a value function and an optimal policy, which can depend on how the Z**ₜ variables are handled. In the first option, where the values can be quantized, both lookups are exact, as all possible values can be defined over a course of an iteration. In the second option, where the values can be continuous, the value-function lookup can be performed via linear interpolation. In various embodiments, the policy-function lookup can be performed by nearest value since outputs are discrete. In various embodiments, an algorithm to determine an optimal solution to the operational planning problem (13) may be similar but with the X*ₜ and V*ₜ variables removed.

In terms of the dynamic programming sets, the algorithm complexity is on the order of |T×X×U|. The relationship illustrates a property of dynamic programming, which is that the complexity is linear in the problem horizon. Therefore, the sizes of X and U can be analyzed. For the states, Z can represent possible values of the Z**ₜ states. In various embodiments, the possible values of the Z**ₜ states are quantized. In various embodiments, the possible values of the Z**ₜ states are chosen grid points. Thus,

$$\vert X \vert = {2}^{\vert X \vert} {\vert Z \vert}^{\vert R \vert \vert {W}^{*} \vert}$$

in which W* can represent the set with the maximum number of overlapping windows within the problem. All possible windows w∈W may not be of concern, according to various embodiments. For example, only the windows w∈W that are currently active may be of concern. In various embodiments, goals may be enforced at the end of each year. There may be no overlapping windows, which can mean |W*|=1. For an example relating to inputs, a worst case is can be that every possible design change and operational action could be taken at each time point. In this situation, |U| grows exponentially in both |X| and |U|. However, the relevant set can be much smaller. Due to single-period budget constraints, it can be too costly to make more than one design change and possibly to take more than one action. Under these restrictions, linear scaling can apply to produce.

$$\vert U \vert = \vert U \vert \vert X \vert$$

Thus, the practical time complexity for the two optimization problems is as follows:
Design Optimization

$$( 5 ) \sim O ( \vert T \vert {2}^{\vert X \vert} {\vert Z \vert}^{\vert R \vert} \vert U \vert \vert X \vert )$$

Operational Planning

$$( 13 ) \sim O ( {\vert T \vert \vert Z \vert}^{\vert R \vert} \vert U \vert )$$

Although large instances can be intractable with the scaling, smaller sized problems can be reasonable.

### Parameter Modeling

In various embodiments, a functional form for resource-consumption models and cost functions may not need to be specified. For example, when using the dynamic-programming solution strategy, a functional form for resource-consumption models ρᵣₜ(⋅) and cost functions αₜ(⋅) does not need to be specified.

### Decision Effects

Resource consumption that results from a specific set of decisions can be important to analyze. The dependence of resource consumption can be reflected by the ρᵣₜ(⋅) function that appears in (2). The problem can be agnostic to the outputs of the function, and can reflect an output of a detailed simulation model based on a current design state and operational actions taken. However, a common functional form can cover many relevant cases.

In various embodiments, a total consumption of a given resource r∈R is by a sum of consumption within a given set of categories c∈Cᵣ. For example, total carbon emissions associated with operation of a building can be derived from, for example, space heating, space cooling, lighting loads, plug loads (i.e., appliance electricity use), and/or other sources. In various embodiments, the situation would not apply to implementation cost if it is considered to be a resource (e.g., to enforce per-period budgets on costs associated with actions). That case can be handled similarly to the cost function discussed herein.

For appropriate resources, ρ̅_{crt} can be used to denote a baseline resource consumption with all decision variables (i.e., all the Xₓₜ and Uᵤₜ) equal to zero. For each design decision and operational action, a reduction fraction η_{acrt}<1 and an absolute offset δ_{acrt} can be defined, with a new index α∈X∪U covering both categories. In some embodiments, only one of the parameters can be nonzero for a given action. It can be possible that η_{acrt} does not vary over time. In various embodiments, the design-change variables V*ₜ can be omitted from the model, as they may not have a significant impact on resource consumption. In various embodiments, design-change variables V*ₜ can be included (e.g., if a given design change would provide only partial benefit in the period it is implemented). The resource consumption is then given as follows:

$${ρ}_{rt} ( {X}_{* t} , {U}_{* t} , {V}_{* t} ) := {\sum }_{c ∈ {C}_{r}} ( {\overline{ρ}}_{crt} {\prod }_{x ∈ X} ( 1 - {η}_{xcrt} {X}_{xt} ) {\prod }_{u ∈ U} ( 1 - {η}_{ucrt} {U}_{rt} ) - {\sum }_{x ∈ X} {δ}_{xcrt} {X}_{xt} - {\sum }_{u ∈ U} {δ}_{ucrt} {U}_{rt} ) \qquad ( 14 )$$

As shown in (14), the total resource consumption is given by the combination of fractional reductions, which multiply across multiple decisions, and direct offsets that add.

Equation (14) demonstrates that reduction actions can be subject to diminishing returns, while offsetting actions may not be. For example, three possible design upgrades for a building are: (a) improving insulation to reduce cooling loads, (b) upgrading to more efficient cooling equipment, and (c) installing on-site photovoltaic (PV) panels. All three can be assumed to be sized so as to individually reduce carbon emissions associated with space cooling by 50%. Option (a) affects emissions by reducing the cooling load, while option (b) reduces the electricity required to produce that cooling load. Because the actions apply in series, their combined effect is multiplicative (i.e., if both are implemented, associated emissions are not reduced by 100% but 75%). By contrast, option (c) serves to offset the electricity obtained from the grid with zero-emissions electricity obtained on site. In various embodiments, the building could sell excess electricity back to the grid, and thus the PV panels would reduce emissions by the full amount of their production regardless of the operation of the building. In terms of the above model, the situation would map to η_{xcrt}=0.5 for options (a) and (b), with δ_{xcrt}=0.5ρc̅rt for option (c). Determining values of these parameters for specific decisions can require separate modeling, with variable degrees of difficulty according to different embodiments. If a site-specific simulation model is available, values could be determined accordingly. In various embodiments, machine-learning methods could be applied to datasets.

The model of (14) is nonlinear, which means it can be challenging for optimization algorithms. However, if (2) is replaced by the inequality Yᵣₜ≥ρᵣₜ(X*ₜ, U*ₜ, V*ₜ), a convex reformulation can be made as follows:

$$\begin{matrix}{N}_{crt} = {\sum }_{x ∈ X} log ( 1 - {η}_{xcrt} ) {X}_{xt} + {\sum }_{u ∈ U} log ( 1 - {η}_{ucrt} ) {U}_{ut} & c ∈ {C}_{r} , r ∈ R , t ∈ T \\ {P}_{crt} \geq exp ( {N}_{crt} ) & c ∈ {C}_{r} , r ∈ R , t ∈ T \\ {Y}_{rt} \geq {\sum }_{c ∈ {C}_{r}} {ρ}_{crt} {P}_{crt} - {\sum }_{x ∈ X} {δ}_{xcrt} {X}_{xt} - {\sum }_{u ∈ U} {δ}_{ucrt} {U}_{ut} & r ∈ R , t ∈ T\end{matrix} \qquad ( 15 )$$

The key property is that log(1−ηX)=log(1−η)X for binary X and η<1. By replacing the second constraint with a piecewise-linear approximation of the exponential function, a fully linear formulation can be obtained. In various embodiments, the linear formulation is approximate. When solving via dynamic programming, the properties may not be relevant, but they could be used to solve larger instances (e.g., with many possible design decisions and unique resources) via mixed-integer programming where dynamic programming is no longer tractable.

An additional variant of the optimization problem to be solved can be expressed as follows:

$$minimize ( 4 ) over {X}_{xt} , {U}_{ut} , {V}_{xt} , {Y}_{rt} , {Z}_{rwt} , {N}_{crt} , and {P}_{crt} subject to ( 1 ) , ( 6 ) , ( 7 ) , and ( 15 ) \qquad ( 16 )$$

The specific variant in (16) involves making a piecewise linear approximation of exp(⋅) so that the problem becomes a mixed integer linear program.

In various embodiments, standard models for benefits provided by standard classes of design changes may be implemented. The standard models can be developed, for example, via simulation across multiple climate zones so that values for a specific building can be calculated automatically.

### Baseline Resource Consumption

For both the design optimization and operational planning problems, a forecast of resource consumption associated with each action at each time point can be required. Based on model (14), a parameter to provide can be a baseline resource consumption ρ̅_{crt} for each use category c∈Cᵣ and resource r∈R. In addition, for design decisions that offset use (e.g., PV panels), the amount of offset δ_{acrt} may need to be forecasted as well. In various embodiments, all of the quantities can be forecasted independently, with χₜ denoting the forecasted value at time point t∈T. To develop a forecast for χₜ, two separate model pieces can be fit: first, a deterministic model μₜ can give the mean value, and second, a stochastic autoregressive noise model ∈ₜ can give the distribution of deviations from that mean. The resulting model is a multivariable normal distribution, which can be amenable to aggregation and conditional sampling.

A mean model μₜ can be fit via any reasonable regression technique. However, in various embodiments, there can be small training datasets with missing values. As a result, a linear approach can be used where available data points for χₜ are fit to a linear combination of basis functions φ_{bt} with b∈B indexing the chosen set of functions. For example, seven piecewise-constant basis functions could be used to capture behavior associated with days of the week, and/or spline basis functions could be used to model smoothly varying seasonal transitions. Once the basis functions have been chosen, parameters B_{b} can be fit via standard least-squares regression as follows:

$$\begin{matrix}min \\ {B}_{b}\end{matrix} \qquad {\sum }_{t ∈ T} {( {𝒳}_{t} - {\sum }_{b ∈ B} {B}_{b} {ϕ}_{bt} )}^{2}$$

In various embodiments, data is missing for specific values of t. The terms can then be omitted from the sum. Given the optimal solution B*_{b}, the mean model can be shown as:

$${μ}_{t} := {\sum }_{b ∈ B} {B}_{b}^{*} {ϕ}_{bt}$$

which can be used to fit the stochastic noise model.

To fit a noise model, deviations ∈ₜ:=χₜ−μₜ of an actual value from a mean can follow a linear autoregressive model for a given order. Mathematically, this can be expressed as:

$${ϵ}_{t} = {\sum }_{n ∈ N} {A}_{n}^{*} {ϵ}_{t - n} + {ξ}_{t} , \qquad {ξ}_{t} \sim 𝒩 ( 0 , {σ}^{2} )$$

in which N:={1, . . . , N} can denote a chosen model order, A*ₙ can be optimal model coefficients, [symbol] (⋅) can be a standard normal distribution, and σ can be a random standard deviation of a one-step stochastic error. Values for A* can be obtained via least-squares regression:

$$\begin{matrix}\begin{matrix}min \\ {A}_{n}\end{matrix} & \frac{1}{\vert T \vert} {\sum }_{t ∈ T} {( {ϵ}_{t} - {\sum }_{n ∈ N} {A}_{n} {ϵ}_{t - n} )}^{2} & s . t . & {\sum }_{n ∈ N} \vert {A}_{n} \vert \leq 1 - δ\end{matrix}$$

In various embodiments, a constraint is included in the least-squares regression to ensure that the resulting model is stable with margin δ>0. Variance σ² can be set to a value of an optimal objective function. Time points where χₜ (as used to calculate εₜ) is missing can be omitted from the sum.

In various embodiments, a two-step approach can be followed. In the two-step approach, a property obtained can be that a sequence χ*:=(χ₁, . . . , χ_{|T|}) can be an affine transformation of independently and identically distributed one-step noise terms χₜ. The sequence can itself distributed as a multivariate normal distribution:

$${𝒳}_{*} \sim 𝒩 ( {μ}_{*} , {Σ}_{**} )$$

In various embodiments, μ*:=(μ₁, . . . , μ_{|T|}) may be from the mean model, and Σ_{tt′} can give an autocovariance between times t and t′∈T. The autocovariance can be obtained, for example, by iterating Yule-Walker equations for fit parameters A*ₙ and σ². First, when some points in the χ* sequence have been observed, a conditional density for the remaining points can also be a multivariate normal distribution. Parameters of the multivariate normal distribution can be calculated explicitly. Second, aggregations of χ* over given time windows can be expressed as a linear transformation, and yield another multivariate normal distribution. This property can mean the original model can be fit in accordance with a faster sample rate (e.g., daily) as used by the operational planning problem, and it can be exactly aggregated to a slower sample rate (e.g., monthly) for the corresponding design optimization problem.

### Cost Function

In various embodiments, a simple linear cost function with fixed costs associated with each decision, with exponential discounting to account for the time value of money, can be used. In various embodiments, defining parameters α̅ₐ for a∈X∪U for nominal costs and γ∈(0, 1] as the discount factor can give a cost function

$${α}_{t} ( {X}_{* t} , {U}_{* t} , {V}_{* t} ) := {γ}^{t} ( {\sum }_{x ∈ X} {\overline{α}}_{x} {V}_{xt} + {\sum }_{u ∈ U} {\overline{α}}_{u} {U}_{ut} ) \qquad ( 16 )$$

in which γ′ denotes standard exponentiation for t∈{0, 1, . . . }. In various embodiments, implementation cost can be treated as a resource to be constrained. In such embodiments, a corresponding ρᵣₜ(⋅) function can take the same form as (16) with γ=1 to remove the discounting effect.

In various embodiments, costs associated with resource consumption can be significant. The costs and/or resource consumption can also be included in the objective function. For example, if a design change significantly reduces electricity consumption, then the optimizer can effectively be credited with reduction in associated operational cost. In such cases, cost functions αₜ(⋅) can be augmented with models of the form (14), with a modification that ρ̅_{crt} and δ_{acrt} parameters previously expressed in units of energy (or other sustainability metric) can be scaled by the appropriate prices of those resources. In various embodiments, the change can lead to a nonlinear objective function, but convexification and linearization can be achieved with auxiliary variables and constraints similar to those in (15).

In various embodiments relating to design optimization, decisions can be assigned a dollar value, thus optimizing actual economic cost directly. However, in the context of the operational planning problem, possible curtailment actions may not have an actual cost. For example, the “cost” associated with adjusting thermostat setpoints is that building occupants will be less comfortable. If all of the curtailment actions are of the same type (e.g., all thermostat setpoint changes, just of different values), then it is possible that comfort models could be used to estimate the intangible costs in consistent units. However, if actions are very different, the fictitious costs can be assigned manually so that actions are taken in accordance with established priorities. If the priority is to achieve a sparse solution (i.e., where a couple of curtailment actions are taken), costs for all actions can be set to a high value, with further minor adjustment based on preferences. If the priority is to achieve a uniform solution (i.e., where similar actions are taken each day), costs for the preferred actions can be kept low, and costs for other actions can be appropriately increased.

### Stochastic Modeling

Models of annual energy consumption and generation for a building can be determined. First, a daily model with |T|=365 suitable for the operational planning problem can be fit. In various embodiments, aggregation can occur on a monthly basis. For example, aggregation on a monthly basis gives |T|=12 to use for design optimization. A mean model can first be fit using a set of basis functions. For both generation and consumption, linear regression can be applied against a basis of periodic cubic splines (13 knots) covering a year. The models can be labeled, for example, “Generation” and “Consumption,” respectively. A variant of the consumption can be fit such that the variant that adds seven indicator functions (i.e., one for each day of the week) to the basis, which can be labeled “Consumption*.” From the resulting mean models, deviations can be calculated, and a 7th-order autoregressive model can be fit to the data, which produces a multivariate normal distribution for each category. Both daily and annual cumulative values can be calculated.

The models described above can be verified to be reasonable by analyzing the resulting distributions for one-step noise terms ξₜ. For example, using an AR model, the values can be independent and identically distributed normal variates. In various embodiments, the values are not correlated in time. Autocorrelation and a density estimate of the noise distribution for each model can be calculated. In various embodiments, a value for the Generation decays quickly to zero and is consistent with expectations from the model described above. The simple Consumption model illustrates strong 7-day correlation, which can result from the weekly operating cycle of the building not being captured by the simple mean model. In various embodiments, the day-of-week basis functions can be added to the Consumption* model. For example, the behavior may be eliminated and give reasonable autocorrelation. Both the Consumption and Consumption* models of error distribution may agree with the assumed normal distribution. The Generation model may exhibit clear negative skew. In various embodiments, the negative skew can be due to the fact that weather (e.g., cloudiness) has a stronger negative effect on PV generation. The resulting model can be used for operational planning purposes.

Values from the fit daily models are aggregated monthly to use for the design optimization. Converting the overall models can be performed via transformation by a 0/1 matrix, where the 1 in each column is in the row of the month containing that day. However, the effectiveness of design changes may depend on the category of energy consumption. Thus, energy consumption can be disaggregated into four categories. A “Cooling” category can be extracted on a basis of daily degree hours (i.e., a time integral of outside temperature in excess of 65° F.) computed from hourly weather data. In various embodiments, the remaining load can be split between “Heating,” “Lighting,” and “Other” based on typical proportions of electricity use in commercial buildings. For example, “Heating” can refer to hot-water heating used for domestic purposes. Daily breakdown and monthly aggregations can be calculated. Uncertainty bounds may or may not be modeled, but can be available from the process. The categorized and aggregated data can be used by the design optimization problem.

### Design Optimization

The design optimization problem can be solved to schedule design changes and operational actions. For this example, it can be assumed a building has not yet installed PV panels and will consider installation split into three separate phases that can be implemented or not based on optimization results. In addition, three different building upgrades can be considered, as well as two different sizes of emissions credits that can be obtained on a monthly basis as operational actions. The full set of decisions are as shown below in Table 1. In various embodiments, based on one-step budgets, one design change and one operational action can be taken each period. These parameters lead to 2⁶=64 unique design states and 6×2=12 unique decisions (i.e., design changes and operational actions) that can be taken. The sustainability goals can be to reduce net energy consumption by 18% annually over the next five years, which, if achieved, will yield 90% total reduction in the final year.

TABLE 1

| Name | Effect | Cost |
|---|---|---|
| Upgrade Windows | Reduce Cooling by 20% | 2 |
| Upgrade Cooling | Reduce Cooling by 40% | 4 |
| Upgrade Heating | Reduce Heating by 35% | 5 |
| Install PV Phase 1 | Offset with 40% of Generation | 10 |
| Install PV Phase 2 | Offset with 35% of Generation | 12 |
| Install PV Phase 3 | Offset with 25% of Generation | 15 |
| Obtain Small Credit | Offset 25% of monthly total | 2 |
| Obtain Large Credit | Offset 50% of monthly total | 2 |

To optimize the problem, the interpolated dynamic programming strategy discussed above can be applied using grid points for the accumulated load state. The problem can be solved assuming mean values for energy consumption. The resulting optimized load can be calculated and/or modeled. For example, one hundred random instances sampled from stochastic models can be solved. A distribution of design decisions can be modeled. From the results, it can be demonstrated that the design problem achieves its primary goals. Load trajectories can be shown, and, according to the example, are below the targets. In various examples, the target may be temporarily exceeded, but may be ultimately met if remaining months have net negative load due to production by PV panels. The targets are achieved primarily by implementing PV phases 1 and 2, followed by upgrades to the heating and cooling system. Based on chosen costs and horizon, the optimal solution elects for obtaining some emissions credits in the final year, rather than implementing the final PV phase 3. If such behavior is undesirable, for example, it can be removed by adding a terminal constraint requiring the design state of the system to be fully sustainable (i.e., meet the target loads indefinitely without taking operational actions).

To assess impact of the solution methods, the same problem can be solved using a variety of strategies, according to various embodiments. For example, using dynamic programming (DP), either the interpolated or quantized forms can be used as discussed above, with a specified grid size or quantization, respectively. For mixed integer linear programming (MILP), the formulation presented in (15) can be used, approximating the exp(⋅) function with tangents at 0, −0.5, −1, −2, −3, and −5, with a specified relative gap tolerance given to the solver. MILP instances can be solved using HIGHS. From each resulting solution (i.e., values of Uᵤₜ and Vₓₜ), the objective function and infeasibility can be recalculated based on the original exact parameters. Results are shown in Table 2. According to the table, it is shown that all approaches can find high-quality solutions. For DP, when the grid size is large enough, solutions can be nearly optimal with zero infeasibility, according to various embodiments. For MILP, the approximation is very tight, yielding similar solutions, according to various embodiments. The solution times for DP can scale significantly with grid size, so the MILP method can be preferred for large instances. The DP implementation is not optimized for efficiency, and thus solution times may not be directly compared to those of MILP. However, DP may be suitable for modestly-sized design-optimization problems.

TABLE 2

| | | Grid | Time | | Infeasibility |
|---|---|---|---|---|---|
| Method | Strategy | Size | (s) | Objective | (MW · h) |
| DP | Interpolate | 21 | 0.5 | 39.35 | 0.0 |
| DP | Interpolate | 101 | 6.1 | 37.22 | 1.8 |
| DP | Interpolate | 1001 | 61.0 | 37.85 | 0.0 |
| DP | 5.0% Quantization | 29 | 1.0 | 32.40 | 71.0 |
| DP | 1.0% Quantization | 143 | 8.6 | 38.81 | 10.7 |
| DP | 0.1% Quantization | 1413 | 86.1 | 37.82 | 0.0 |
| MILP | 5.0% Gap | N/A | 0.6 | 37.89 | 0.0 |
| MILP | 1.0% Gap | N/A | 5.0 | 37.85 | 0.0 |
| MILP | 0.1% Gap | N/A | 8.8 | 37.82 | 0.0 |
| MILP | 0.0% Gap | N/A | 14.8 | 37.82 | 0.0 |

### Operational Planning

As changes identified in the design optimization are implemented, it can be necessary to operate the building efficiently so as to achieve the desired sustainability goals. To illustrate this procedure, it can be assumed that the building has implemented all three PV system installations with a goal of achieving full net-zero energy operation in a sixth year and beyond. Because a PV system capacity can be slightly lower than total consumption, it can be necessary to take discretionary curtailment actions if the goal is to actually be achieved. For example, three possible curtailment levels and a no-curtailment option can be considered, as shown in Table 3. Costs can grow quadratically to encourage consistent low and medium curtailment while avoiding high curtailment as much as possible.

TABLE 3

| Curtailment | Reduction | Cost |
|---|---|---|
| None | 0% | 0 |
| Low | 2% | 1 |
| Medium | 5% | 6 |
| High | 10% | 25 |

To illustrate the resulting trajectory, a random realization of generation and consumption are chosen from the daily stochastic models and re-optimized each day based on the actual values to illustrate the resulting trajectory described above. At each step, the model can assume that baseline consumption and generation will be equal to the conditional mean of the model given realized values so far. The action chosen for the current day is implemented, and the system is advanced by one day. Results can be labeled, for example, “Closed-Loop.” For comparison, the sequence of planned trajectories resulting from each optimization can also be shown, labeled “Open-Loop.” In addition, two different alternatives can be compared: “Perfect,” in which the optimizer knows the actual realization, which is impossible in practice but indicates best-case performance, and “Naïve,” in which the plan made on the first day, which assumes mean values for consumption and generation, is followed throughout the year without any re-optimization. Due to re-optimization, the Closed-Loop trajectory stays reasonably close the Perfect solution, whereas the Naive trajectory fails to revise its plan and thus does not achieve net-zero energy use for the year. This observation illustrates that the feedback loop in the closed-loop procedure is able to adequately account for uncertainty in future consumption and generation.

The previous simulation procedure can be repeated for 1,000 random realizations of consumption and generation to assess robustness. In each case, the curtailment cost (i.e., the sum of the costs of the chosen sequence of curtailment actions) and the net energy consumption resulting at the end of the year can be calculated. The overall goal can be to achieve low cost with a high probability of meeting net-zero status. Negative values of net energy can be acceptable, but can indicate that unnecessary curtailment actions were taken, as reflected in the cost. In some embodiments, net-zero use can be achieved without any curtailment, while in other embodiments still, meeting the goal is not possible even with high curtailment each day. However, the goal can be achieved through a mix of low and medium curtailment, which can correspond to an average daily cost of about 5 units. The Closed-Loop solution does not perform as well as Perfect, but its cost is approximately 40% higher, according to the example. In addition, the net-energy goal is achieved, with 87% of instances at or below 1% final net energy, compared to 99% for Perfect, according to the example. The Naive solution has constant curtailment cost, as it follows the same initial plan for all realizations. Furthermore, it achieves the 1% final net energy benchmark only 67% of the time, often performing unnecessary curtailment. Overall, the results illustrate that closed-loop operational planning can be necessary to robustly achieve established sustainability goals.

### User Interface

The ECM optimization system 1105 may provide one or more user interfaces to various devices and the ECM optimization system 1105 may receive one or more responses to customize solutions provided by the sustainability planning optimizer. Customizations to the solutions can be indicated on the user interface, which can be translated into modified constraints (for example, adjusted variable bounds) in the underlying MILP optimization problem. The solver can then find an optimal solution that respects the new constraints, which can then be displayed for acceptance or further customization. In various embodiments, the user interface may be displayed on the user device 1150.

### Effects of Bound Constraints

The solution customizations can be enforced within the MILP optimization by adjusting bounds on the primary decision variables. In various embodiments, the variables may be binary. As such, there can be three valid combinations for lower and upper bounds. The combinations are summarized below in Table 4:

TABLE 4

| Variable | LB | UB | Effect |
|---|---|---|---|
| Uᵤₜ | 0 | 1 | Action u may be taken at time t. |
| | 0 | 0 | Action u not to be taken at time t. |
| | 1 | 1 | Action u to be taken at time t. |
| Vₓₜ | 0 | 1 | ECM x may be implemented at time t, if not already. |
| | 0 | 0 | ECM x not to be implemented at time t, |
| | | | but could be at other times. |
| | 1 | 1 | ECM x to be implemented exactly at |
| | | | time t and not any other time. |
| Xₓₜ | 0 | 1 | ECM x may be implemented at or before time t. |
| | 0 | 0 | ECM x not to be implemented at or before time t. |
| | 1 | 1 | ECM x to be implemented at or before time t. |

As shown in Table 4, Vₓₜ represents the choice to implement ECM x at time t, whereas Xₓₜ gives the state of whether ECM x has been implemented as of time t.

In various embodiments, all variables may have {0,1} bounds by default. In various embodiments, variables having {0,1} bounds can give full freedom to the optimizer. By modifying one or more variable bounds to match user customizations, the optimizer may have less freedom but can only return a solution matching the user's requirements.

### Initial Optimal Solution

After an initial optimization has been run according to the processes described herein, the optimizer's current solution can be displayed on a user interface (UI). For example, decisions (i.e., when ECMs are implemented, and actions are taken) and predicted emissions over the horizon maybe displayed. The user can then be presented with various UI controls to modify the solution and see a resulting impact on emissions.

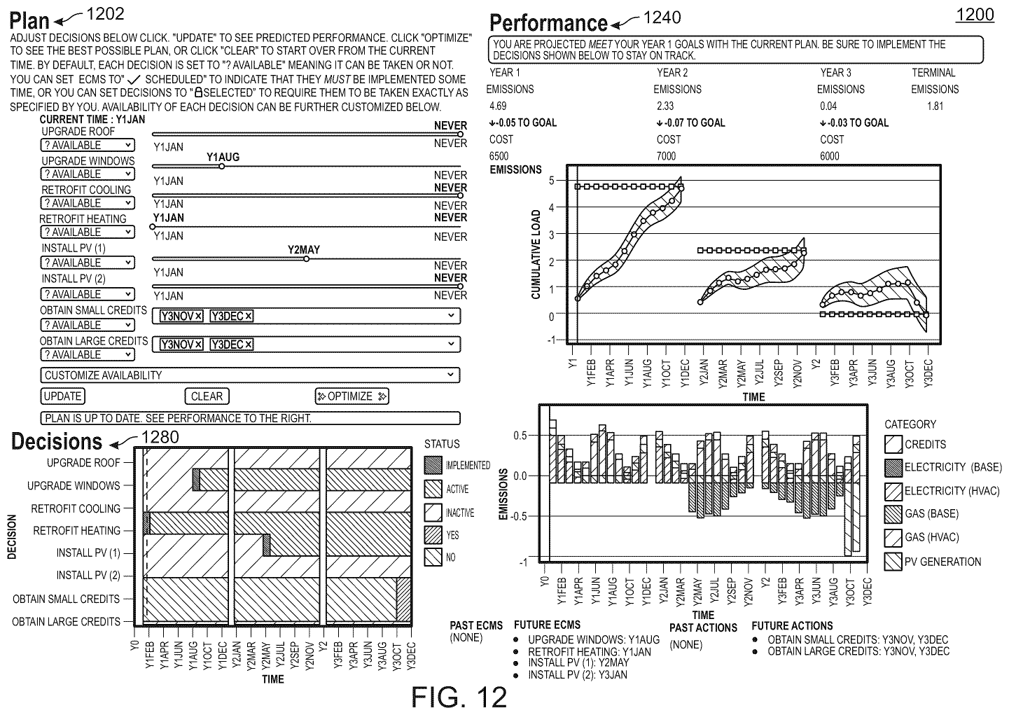

FIG. 12 illustrates an example user interface 1200. The user interface 1200 can include, for example, a plan tab 1202, a performance tab 1240, and a decisions tab 1280. According to FIG. 12, under the plan tab 1202, users can adjust when ECMs are implemented via selectable elements or when actions are taken by choosing time points in the multi-select menus. By clicking an “update” selectable element, the performance metrics and plots can be updated based on any changes the user has made. The decisions tab 1280 can display the decisions made in the plan tab 1202. Under the performance tab 1240, the user can see projected emissions levels and costs for multiple years, and total emissions at a terminal time. The performance tab 1240 may also indicate how close to meeting their yearly emissions goals the user is projected to be. Under the performance tab 1240, the user interface may also display one or more displays of data indicating emissions information. In various embodiments, the UI described with respect to FIGS. 12, 13, and 18 may include a text-summary of the optimization results. The text summary may be generated using generative artificial intelligence. For example, the ECMs that have been and will be implemented, listed under decisions tab 1280, 1380, and 1780, may be translated from bulleted or listed items into prose or a substantial explanation. The text may include additional information about why items have been scheduled for specific times (e.g., a user has selected the item to be implemented at that time or it is the most optimal time at which to implement the item).

### Overall Constraints

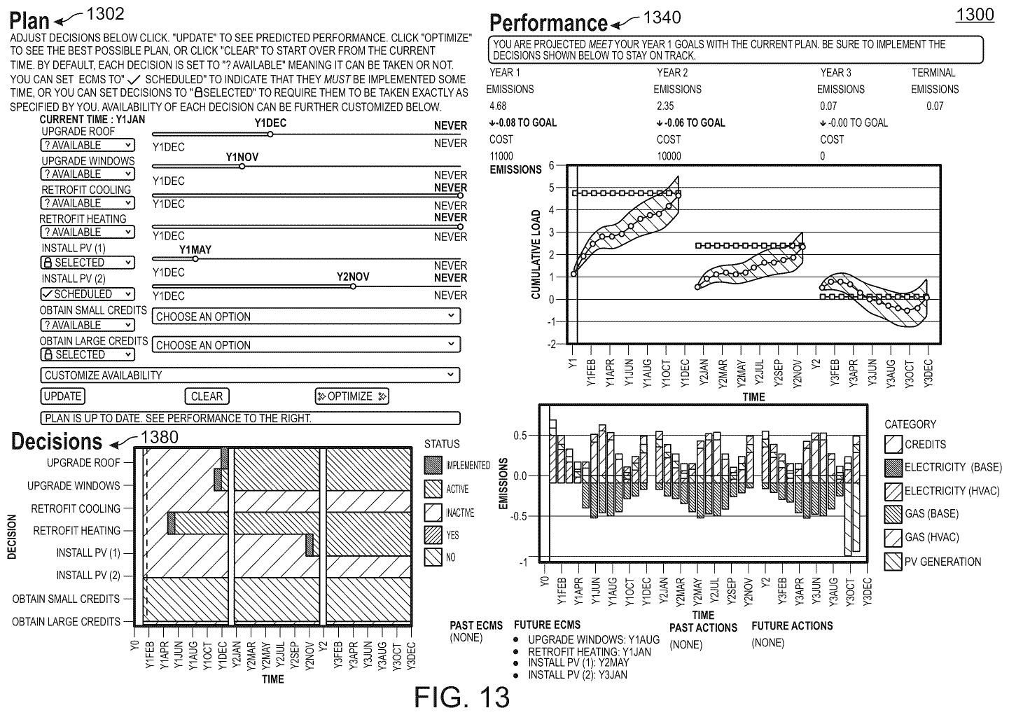

FIG. 13 illustrates an example user interface 1300 including the optimizer's solution. The elements of FIG. 13 can be analogous to the elements of FIG. 12 and may perform the same functions. The user interface 1300 can include, for example, a plan tab 1302, a performance tab 1340, and a decisions tab 1380. According to FIG. 13, under the plan tab 1302, users can adjust when ECMs are implemented via selectable elements or when actions are taken by choosing time points in the multi-select menus. By clicking an “update” selectable element, the performance metrics and plots can be updated based on any changes the user has made. The decisions tab 1380 can display the decisions made in the plan tab 1302. Under the performance tab 1340, the user can see projected emissions levels and costs for multiple years, and total emissions at a terminal time. The performance tab 1340 may also indicate how close to meeting their yearly emissions goals the user is projected to be. Under the performance tab 1340, the user interface may also display one or more displays of data indicating emissions information.

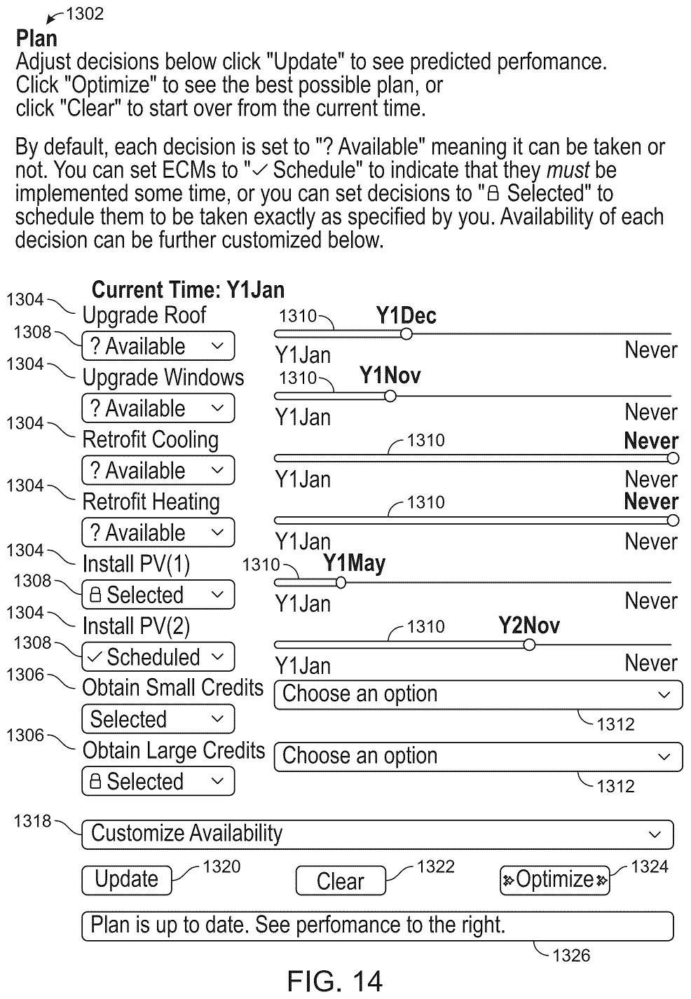

Referring now to FIG. 14, a plan tab 1302 of the user interface 1300 is shown in greater detail. Users can adjust when ECMs 1304 and/or actions 1306 are implemented via selectable elements 1310 or when actions are taken by choosing time points in the multi-select menus 1312. In various embodiments, the plan 1302 can optimize and/or project sustainability goals for various numbers of years. In the exemplary embodiment shown in FIG. 14, the user can plan for optimizations for up to three years. In various embodiments, the user can adjust how many years the optimizer plans and/or projects for. In various embodiments, a user may dislike some aspects of the optimized solution but does not want to have to manually reconfigure the full solution. In such embodiments, the user's desired customizations can be communicated to the optimizer via overall constraints. In various embodiments, each ECM 1304 or action 1306 may be marked as “Available” by default in a dropdown menu 1308 below each ECM or action. ECMs can include, but are not limited to, upgrading a roof, upgrading windows, retrofitting cooling, retrofitting heating, and installing photovoltaics (PVs). Examples of actions include, but are not limited to, obtaining small credits and obtaining large credits. In various embodiments, credits may include carbon credits and/or another type of credit.

In various embodiments, the dropdown menu 1308 can have options including, for example, “Available,” “Selected,” and “Scheduled” (e.g., as shown in FIG. 14). In various embodiments, “Available” can mean that the optimizer has full control over when that decision is taken. If the user knows specifically when they want a given ECM 1304 or action 1306 to be taken, they can change that value to “Selected,” which can mean the optimizer must keep that decision exactly as indicated on the user interface. For ECMs 1304, there can also be a third option of “Scheduled,” which can mean that the ECM must be taken at some point in the horizon, but not necessarily exactly as indicated. After making any of these choices, the user can click the “optimize” selectable element 1324 to see a new optimal solution given their constraints. If the user wants to change their selections, the clear selectable element 1322 can be selected and the default option for each dropdown menu 1308 will be shown, and any performance metrics and or plots generated will return to a default status. Selectable elements 1310 and options 1312 also return to a default status.

In various embodiments, “Available” is the default dropdown option for ECMs 1304 and actions 1306. If the user has made any changes to their selections, performance metrics and plots of user interface 1300 can be updated by selecting the “update” selectable element 1320. After the “update” selectable element 1320 and/or the “optimize” selectable element 1324 is selected, notification 1326 may appear indicating that the user interface 1300 is displaying information (such as plots in performance tab 1340) corresponding to most updated selections for EMCs 1304 and actions 1306. In various embodiments, notification 1326 may indicate that the plan is not up to date. For example, if a user has modified a selectable element 1314 such that an ECM 1304 will be taken at a later time than what was originally output by the optimizer, but the user has not yet hit the “update” selectable element 1320, then notification 1326 may notify the user that the plan is not up to date.

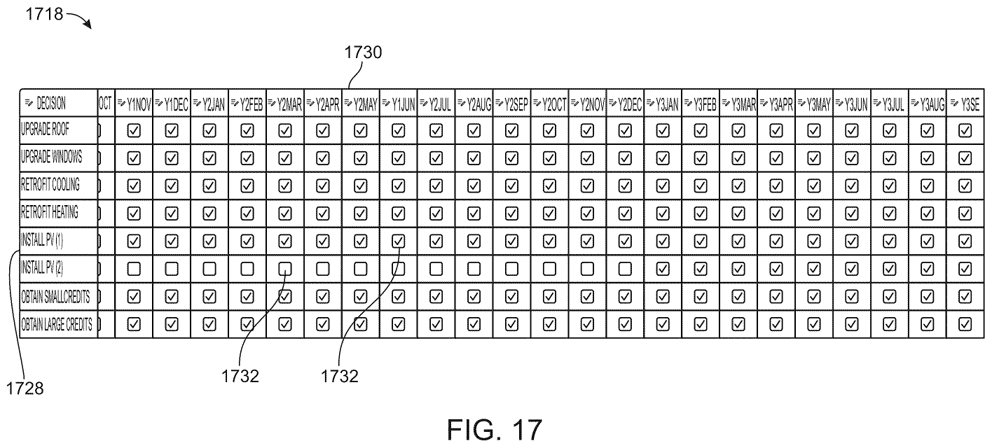

To generate the new solution, the customizations can change the bounds on decision variables (i.e., ECMs 1304 and actions 1306) as discussed above. For example, in the default “Available,” the bounds on Uᵤₜ and Vₓₜ can be left as {0,1}, giving full freedom to the optimizer. For example, if action u is set to be “Selected,” the bounds on Uᵤₜ can be set to {0,0} at all time points t where that action is not taken and {1,1} at all points where it is taken according to the user's UI choices. For example, when an ECM 1304, referred to now as an exemplary ECM x, is “Selected,” the situation may be similar for Vₓₜ, noting that there can be at most one time point where the bounds are {1,1} since each ECM 1304 can only be implemented once. If ECM x is marked as “Scheduled,” then the bounds on Xₓₜ can be set to {1,1} only at the final time point t, meaning the optimizer can choose when to implement the ECM 1304 but must do it at some time. In various embodiments, there may be no analogous cases for actions 1306, and they may not support the “Scheduled” customization. The customize availability dropdown 1318 can provide the user with the availability to use fine-grain customizations to change bounds on ECMs 1304 and/or actions 1306. The fine-grain customizations will be described in greater detail with reference to FIG. 17.

In various embodiments, if too many decisions are “Selected” or “Scheduled,” it is possible that cost budgets cannot be met. However, since budgets are implemented via soft constraints in the MILP, the optimizer can still return a solution that comes closest to meeting budgets while still respecting the customizations.

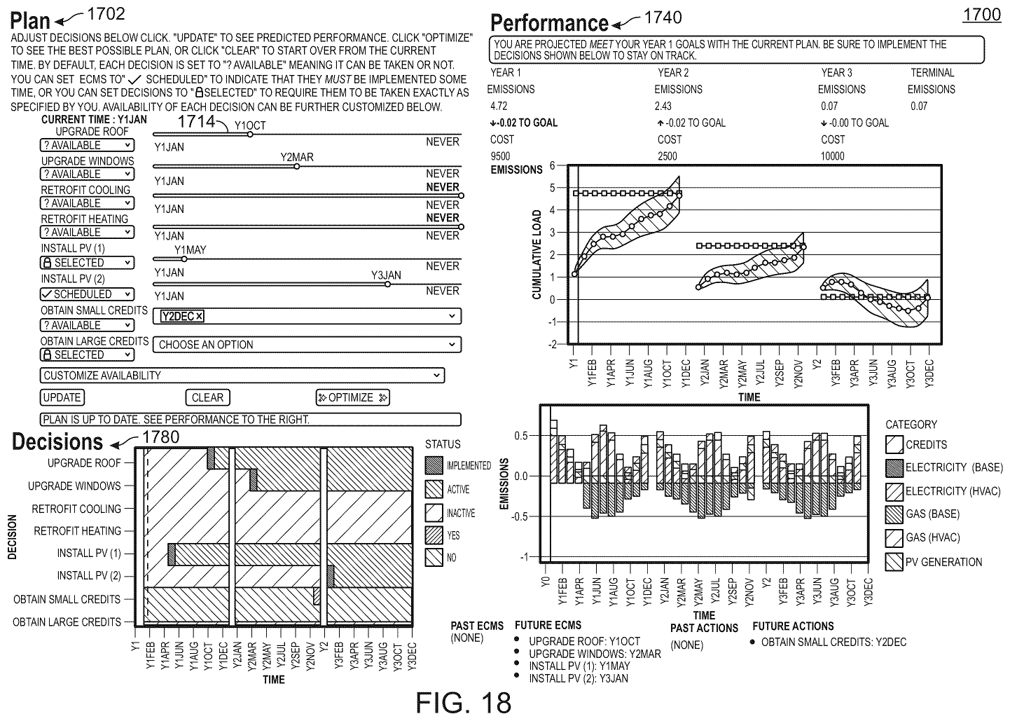

Referring further to FIG. 14, in an exemplary embodiment, a user may want to lock implementation of Install PV (1) to the middle of Year 1, want to select that Obtain Large Credits is never taken, and want to implement or schedule to Install PV (2) at some point. This could be accomplished by the following actions: (1) Sliding the Install PV (1) selectable element to the appropriate time and choosing “Selected,” (2) De-selecting any instances of Obtain Large Credits (for example, the two instances shown in FIG. 12), and choosing “Selected,” and (3) Selecting “Scheduled” for Install PV (2). The plan tab 1302 of FIG. 14 indicates that the above actions have been implemented. Note that the plan tab 1202 of FIG. 12, the plan tab 1302 of FIGS. 13 and 14, and the plan tab 1702 of FIG. 18 illustrate the same features, but with ECMs indicating varying times and/or selections.

Referring still to FIG. 14, the preferences designated by the user are respected by the optimized decisions. For example, Install PV (1) is implemented in Y1May exactly as indicated; the Obtain Large Credits action is never taken, and Install PV (2) is implemented in Y2Nov. None of the decisions were present in the original solution shown as an example in FIG. 12.

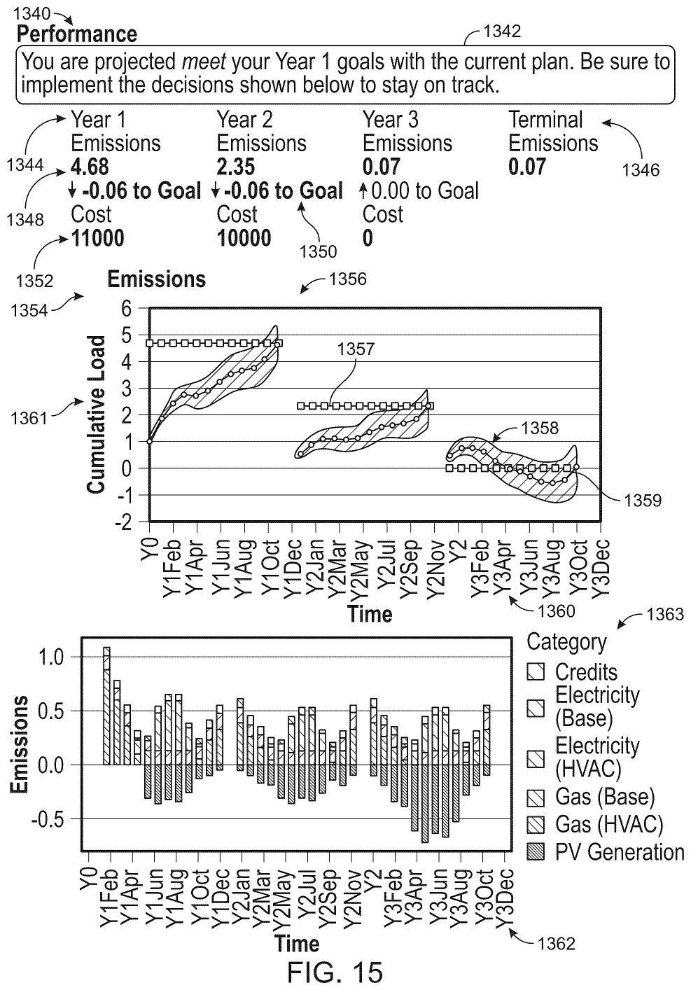

FIG. 15 shows the performance tab 1340 of the user interface 1300. The performance tab 1340 displays performance metrics for the ECMs 1304 and actions 1306 implemented in the plan tab 1302 of FIG. 14. In the performance tab 1340, the optimizer is still able to meet the yearly emissions goals compared to the UI shown in FIG. 12. Notification 1342 indicates to the user that they are projected to meet their year 1 goals with the current plan. In various embodiments, the notification 1342 indicates that the user is projected to meet their goals for another year, such as year 2. In various embodiments, notification 1342 indicates that the user is not projected to meet their yearly emissions goals given the current plan put forth in the plan tab. Time indicator 1344 indicates projected data for a given year. As shown in FIG. 15, the optimization plan shows projections for three years.

In various embodiments, the plan 1302 can optimize and/or project sustainability goals for a greater and/or smaller number of years. In various embodiments, the user can adjust how many years the optimizer plans and/or projects for. At indicator 1346, terminal emissions projections are shown. Emission levels for each year, as well as terminally, is shown at emissions value 1348. The emissions value may be a projected amount of emissions from the building for the year. The emissions value may be measured in kilotons, for example, or another unit of measurement. The performance tab 1340 also includes an indicator 1350 that identifies how the projected yearly emissions value 1348 compares to the projected emissions goal. For example, indicator 1350 can indicate that a given year's emissions need to decrease by 0.06 to meet the stated goal. Cost indicator 1352 indicates the cost of implementing ECMs 1304 and/or actions 1306 in the given year.

The performance tab 1340 can also display emissions data in the form of charts and/or graphs. For example, a chart can display time versus cumulative load, as shown in line graph 1356. The chart can include a yearly emissions goal as well as projected cumulative emissions levels at each month. Referring to line graph 1356, line 1357 indicates the emissions goal for the entire year. Line 1358 connects the cumulative emissions at each month. A point 1359 corresponds to the month on time axis 1360 and value on the cumulative load axis 1361, indicating the cumulative emissions for each month.

Emissions data can also be displayed in a bar chart broken down by type of emission for each month, as shown in bar chart 1362. As shown in the chart, for each month, the amount of emissions generated per category 1363 of usage is displayed. For example, in Y1June, emissions came from base electricity, HVAC electricity, and base gas. Also in Y1June, emissions were offset by PV generation.

As shown in FIG. 15, cost of ECMs and actions taken in year 1 has increased from 19.5 k in the plan tab 1240 of FIG. 12 to 21 k in FIG. 15. The user can then, for example, decide if the customizations are important enough to justify the increased cost. If not, then the user can remove the restrictions under the plan tab 1302 shown in FIG. 14 to return to the original solution.

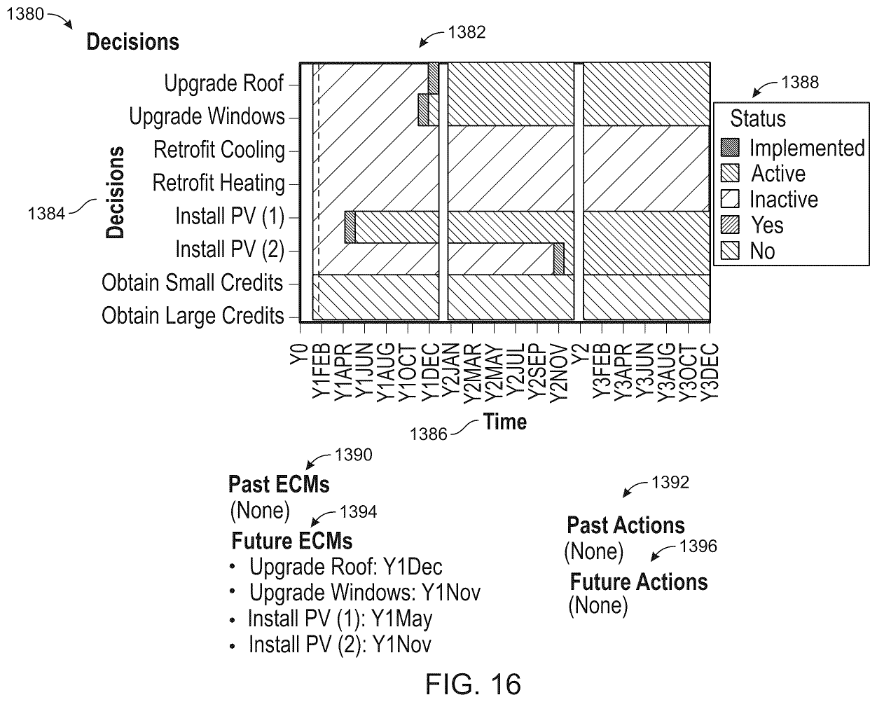

FIG. 16 shows the decisions tab 1380 of the user interface 1300 in greater detail. The decisions tab 1380 can display the selections chosen in the plan tab 1302. For example, a chart 1382 can be displayed under the decisions tab 1380 that indicates a status 1388 of ECM 1304 and/or action 1306. For example, the status 1388 can identify whether decisions are implemented, active, or inactive, and/or if binary decisions are made. For example, the chart 1382 displays that a roof will be upgraded in December of Year 1, as shown in chart 1382, corresponding to the selectable element 1310 of FIG. 14 indicating that a new roof will be implemented at Y1Dec. The status of the decision will be implemented at time Y1Dec. For the remaining time on the chart, the status of the decision can be displayed as active since the upgrade is currently in place. The chart can also, for example, display the binary decision of whether small credits will be bought in a certain month. For example, if small credits are bought in December of Year 3, such as in FIG. 12, the status of Obtain Small Credits will be “Yes” for time period Y3Dec. Since actions 1306 are binary, the month in which the action is implemented has a status of yes, and any other month where the action is not taken will have a status of no.

The decisions tab 1380 can also track what past ECMs or actions have been taken, and/or what future ECMs and/or actions will be taken. For example, in FIG. 16, past ECMs 1390, past actions 1392, future ECMs 1394, and future actions 1396 are displayed. The decisions in FIG. 16 correspond to the planned ECMs 1304 and actions 1306 in FIG. 14. As a result, decisions tab 1380 only shows that future ECMs 1394 will be taken. Under the future ECMs heading, each ECM is listed with the month and year it will be implemented. In various embodiments, if any of past ECMs 1390, past actions 1392, or future actions 1396 alternatively or additionally had items listed, the item and corresponding month and year would be listed.

### Fine-Grained Availability Constraints

In various embodiments, overall constraints may not be sufficient. Therefore, additional fine-grained customization can be available. For example, the user interface can display exactly which time points each decision is available to be taken or implemented. These preferences can be communicated by the user in a timeline view. In various embodiments, the preferences may be hidden under the Customize Availability expander of the plan tab shown in any of FIG. 12-14 or 18 (e.g., 1318). Users can mark a decision as not available by unchecking a corresponding box. FIG. 17 illustrates an exemplary embodiment of a user interface to display the fine-grained customization 1718 corresponding to an exemplary embodiment of user interface 1700 shown in FIG. 18.

Referring further to FIG. 17, the Install PV (2) ECM 1728 has been unchecked for all time periods 1730 prior to Y3Jan. In various embodiments, this UI would correspond to a user adjusting the Install PV (2) selectable element 1732 to Y3Jan under the plan tab. FIG. 17 only shows a subset of the time points, but the UI can be scrolled left or right to see a full set of time points in various embodiments.

If a user un-checks a specific time point, the customization is communicated to the solver by setting the bounds on Vₓₜ (for ECMs) or Uᵤₜ (for actions) to {0,0} in the appropriate time point. This change effectively disables that choice for that time period. If too many decisions are disabled, it may no longer be possible to meet the configured emissions goals. However, if the goals are configured as soft constraints, the optimizer can return the solution that comes as close as possible to meeting them, at which point the user can further revise their customizations.

FIG. 18 shows the updated solution in the user interface 1700 after re-optimizing with these customizations. The Install PV (2) ECM has been delayed to Y3Jan and the optimizer has chosen to add a Obtain Small Credits action in Y2Dec to make up for the lost PV generation and stay on track for Y2 goals. In various embodiments, the optimizer may elect to add, or subtract various ECMs or actions to make up for lost PV generation. In various embodiments, the optimizer may neither add nor subtract any ECMs or actions.

With availability customization, it can be possible to add customizations that are incompatible with previous overall constraints. For example, if an ECM is marked as “Scheduled” but all time points are disabled in the availability table, no solution can possibly respect both customizations. This case can be handled, for example, either by giving preference to one of the two and ignoring the other. Alternatively, a warning could be displayed on the UI and the Optimize selectable element could be disabled until the inconsistency is resolved.

To give more control, each cell in the availability grid 1718 could support three values: Yes, No, and Maybe. These can correspond directly to the MILP bounds {1,1}, {0,0}, and {0,1} for the appropriate Vₓₜ or Uᵤₜ variables. However, it can be possible to cause infeasibilities if the same ECM is marked as Yes multiple times. Thus, additional validation on the UI may be needed to automatically reject such invalid solutions.

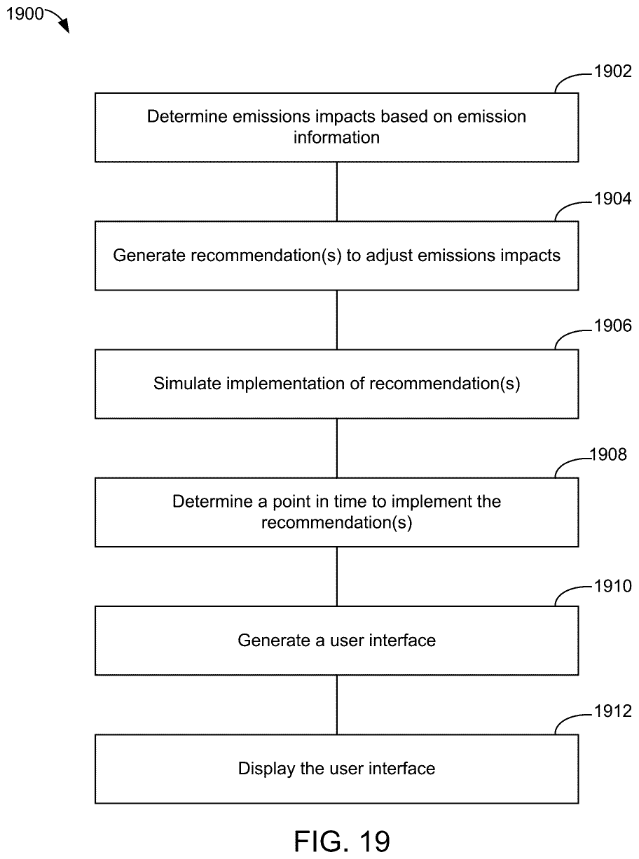

FIG. 19 is a flow diagram of a method 1900 for optimizing energy conservation measures, according to an exemplary embodiment. At least one step of the method 1900 may be performed by at least one of the various systems, devices, and/or components described herein. For example, the network interface 1140 may perform at least one step of the method 1900. As another example, the ECM optimization system 1105 may perform at least one step of the method 1900. In some embodiments, one or more steps of the method 1900 may be repeated, reproduce, omitted, adjusted, and/or otherwise changed.

In some embodiments, at step 1902, emissions impacts can be determined. For example, the impact module 1130 may determine emission impacts for a plurality of pieces of building equipment (e.g., equipment 1160). In various embodiments, the impact module 1130 may determine the emissions impacts based on emission information. For example, the impact module 1130 may determine the emission impacts based on information received by the data receiver 1125.

In some embodiments, emissions impacts may refer to and/or include a carbon footprint of a piece of building equipment (i.e., an amount of carbon generated from operation of the equipment). Emissions impacts may also be impacts of an entire building. For example, emissions impacts may be related to or depend on factors such as building occupancy or building construction. In various embodiments, emissions impacts for a piece of building equipment may be expressed as a percentage or fraction of total emissions for a building. Emissions impacts may be related to a current operating condition of a building.

In some embodiments, at step 1904, a plurality of recommendations can be generated. For example, the recommendation generator 1135 may generate one or more recommendations based on the emission impacts determined in step 1902. As another example, the recommendation generator 1135 may generate recommendations based on information provided by the data receiver 1125. In some embodiments, the recommendation may include and/or indicate adjusts to control strategies for the plurality of building equipment. In other embodiments, the recommendations may include actionable items, actions to implement, and/or credits to obtain. Implementation of the recommendations, generated in step 1904, may result in the emissions impacts of the building and/or the emissions impacts of individual components of building equipment to decrease and/or change.

In some embodiments, at step 1906, implementation of at least one recommendation may be simulated. For example, the processing circuit 1110 may simulate, using the ML model 1122, one or more recommendations generated in step 1904. As another example, the processing circuit 1110 may input one or more parameters, associated with the recommendations, into the ML model 1122 which causes the ML model 1122 to simulate the recommendations. In some embodiments, the processing circuit 1110 may simulate implementation of at least one recommendation of the plurality of recommendations at a plurality of points in time. For example, the ML model 1122 may simulate implementation of a recommendation at a variety of points in time (e.g., installing windows at different months in a year). As another example, the ML model 1122 may simulate one or more spatial configurations for a room in winter months and/or in summer months. In some embodiments, the ML model 1122 may simulate implementation of the recommendations based a plurality of parameters.

In some embodiments, at step 1908, a point in time to implement at least one recommendation can be determined. For example, the processing circuit 1110 may determine, responsive to simulation of the recommendations in step 1906, a point in time to implement a given recommendation. For example, the processing circuit 1110 may determine a given month to install solar panels at the building 10. As even another example, the processing circuit 1110 may determine a given spatial configuration for a room during winter months.

In some embodiments, implementation of the recommendations may include controlling one or more pieces of building equipment (e.g., the equipment 1160). In other embodiments, implementation of the recommendations may include retrofitting and/or replacing one or more pieces of the plurality of pieces of building equipment. In some embodiments, the processing circuit 1110 may determine the one or more points in time responsive to identifying one or more values and/or parameters that solve the optimization problem.

In some embodiments, at step 1910, a user interface can be generated. For example, the processing circuit 1110 may generate one or more user interfaces. As another example, the processing circuit 1110 may generate at least one of the various user interfaces described herein. In some embodiments, the user interfaces may include a graphical representation that indicate recommendations. For example, the graphical representations may indicate the recommendations generated in step 1904. In some embodiments, the user interface may include an element to indicate one or more points in time to implement the recommendations. For example, the element may indicate the points in time determined in step 1908.

In some embodiments, at step 1912, the user interface may be displayed. For example, the user device 1150 may display the user interface generated in step 1910. As another example, an edge device may also display the user interface. In some embodiments, the processing circuit 1110 may transmit one or more signals. For example, the processing circuit 1110 may transmit signals to the user device 1150 which may cause the user device 1150 to display the user interface.

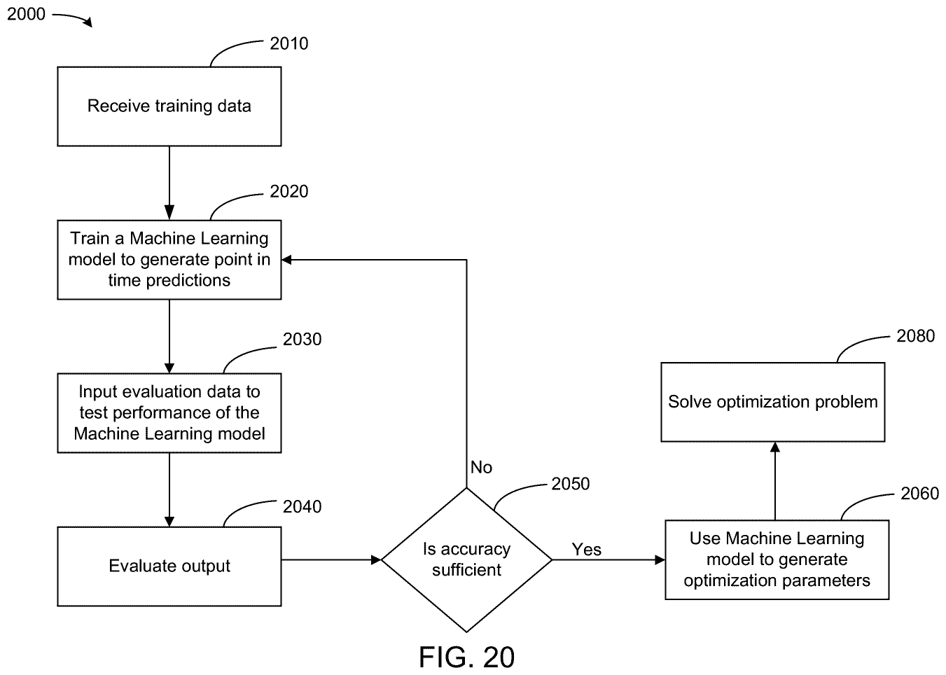

FIG. 20 depicts a flow diagram of a method 2000 for using machine learning to train one or more models, according to an exemplary embodiment. In some embodiments, one or more components of the ECM optimization system 1105 may utilize a machine learning (ML) model trained by the method 2000. As another example, the ECM optimization system 1105 may use a model, trained by method 2000, to generate one or more optimization parameters or constraints used in solving the optimization problem (i.e., the parameters used to determine optimal points in time to implement energy conservation methods in a building). One or more components of the ECM optimization system 1105 may also implement or utilize the ML model to perform one or more functions or actions described herein.

In some embodiments, memory 1120 may store, keep, hold, and/or otherwise maintain at least one ML model 1122. The ML model 1122 may be trained using one or more various ML and/or Artificial Intelligence techniques. For example, the ML model 1122 may be trained using supervised and/or unsupervised learning. In some embodiments, one or more components of the ECM optimization system 1105 may access and/or utilize the ML model 1122. For example, the processors 1115 may utilize the ML model 1122. In some embodiments, the ML model 1122 is trained to generate, predict, or determine at least one optimization parameter or constraint used in the optimization problem described herein.

In various embodiments, the ML model 1122 may be or include regression trees, deep neural networks, nearest neighbor-based models, supervised learning-based models, unsupervised learning-based models, Bayesian models, generative AI models such as transformer (e.g., generative pretrained transformer (GPT)) models or generative adversarial network (GAN) models or other large language models (LLMs), and/or other types of models.

FIG. 20 illustrates a process for training and implementing a machine learning model (e.g., the ML model 1122). The machine learning model may be implemented in the ECM optimization system 1105. The ML model may be used to generate the optimization parameters utilized in the ECM optimization described above.

At step 2010, the processing circuit 1110 may receive training data. For example, the processing circuit 1110 may receive training data from the data sources 1155. As another example, the processing circuit 1110 may receive training data from the remote database 1165. The training data may be, for example, an input parameter. The input parameters may be optimization parameters previous generated for use in the optimization problem to be solved, described above. In some embodiments, the training data may be previously solved optimization problems and corresponding optimization parameters used to generate the solution(s). For example, inputs may be parameters to be implemented that correspond to the optimization of the building. The parameters may be different ECMs to implement in the building. Inputs may also be, for example, time constraints or other user inputs that may determine when ECMs are implemented. The training data may also be previously determined optimizations that meet the given criteria or parameters for performing the optimization. For example, input data may be ECMs that were implemented in a building and the points in time at which the ECMs were implemented.

At step 2020, the ML model is trained to generate point in time predictions. For example, the processing circuit 1110 may input the training data into the ML model. The ML model may be trained using the training data received at step 2010. Using the training data, the ML model may learn to generate optimization parameters for use in solving the ECM optimization problem. For example, the ML model may learn to generate constraints or parameters to be considered, maximized, minimized, etc., when solving the optimization problem. The ML model may learn to generate points in time at which to implement one or more parameters, sustainability measures, and/or ECMs.

At step 2030, evaluation data may be input into the ML model to test the performance of the ML model. For example, the processing circuit 1110 may evaluate the ML model using a portion of the training data that was not used to train the ML model. Evaluation data may be, for example, optimization parameters, emissions impacts of a building, and/or ECMs to be implemented to address the emissions impacts on a building. The evaluation data may be a portion of the training data, received at step 2010, that was flagged for subsequent use in evaluating the ML model.

At step 2040, the output of the ML model is evaluated. For example, the processing circuit 1110 may evaluate the output with the training data and/or evaluation data. The processing circuit 1110 may evaluate the output of the ML model by identifying one or more parameters to utilize when solving the optimization problem. In some embodiments, the processing circuit 1110 may evaluate the output by determining whether the optimization parameters determined by the ML model match the optimization parameters previously determined to be utilized in generating a specific solution to the optimization problem. For example, evaluation data may include optimization parameters and/or values of optimization parameters previously utilized to generate a solution to the optimization problem. The processing circuit 1110 may evaluate the model based on a quantity of determined optimization parameters that match the optimization parameters in the evaluation data.

At step 2050, an accuracy of the output is determined. For example, the processing circuit 1110 may determine the accuracy of the output based on the accuracy being at or above a threshold value of accuracy. As another example, the accuracy may be based on a quantity of optimization parameters correctly identified by the ML model. In this example, evaluation data may include ten ECMs and ten corresponding points in time at which the ECMs were implemented. To continue this example, a threshold for proceeding to step 2050 may be 80% accuracy, or any other value of accuracy. In some embodiments, if the ML model correctly determined eight of ten optimization parameters for use in solving the specific optimization problem, the 80% accuracy threshold may be met.

In some embodiments, the method 2000 may proceed to step 2020 responsive to determining that the output evaluated at step 2040 is not sufficiently accurate, so that the model can be retrained. The ML model may continue to be evaluated until the ML model output obtains a sufficient accuracy level (e.g., accuracy is at or above a threshold value). In some embodiments, the method 2000 may proceed to step 2060 responsive to determining that the output evaluated at step 2040 exceeds the threshold value.

At step 2060, the ML model is implemented or used to generate optimization parameters. For example, the processing circuit 1110 may utilize the ML model 1122 to generate optimization parameters. In some embodiments, the ML model 1122, when implemented, may be able to generate optimization parameters for use in the optimization problem. For example, the output optimization parameters may be the parameters η_{xcrt}, η_{ucrt}, ρ_{crt}, δ_{xcrt}, and δ_{ucrt} in constraint (15) described above.

At step 2080, the optimization problem may be solved using the optimization parameters. For example, the ML model 1122 may solve the optimization using the optimization parameters generated in step 2060. In some embodiments, the ML model 1122 may solve the optimization problem by generating points in time at which one or more parameters can be implemented in a building (e.g., the model is trained and can perform properly).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A Building Management System (BMS) comprising one or more memory devices storing instructions thereon that, when executed by one or more processors, cause the one or more processors to:
determine, based on emission information, emission impacts for a plurality of pieces of building equipment of a building;
generate, using the emission impacts for the plurality of pieces of building equipment, a plurality of recommendations to adjust the emission impacts for the plurality of pieces of building equipment;
simulate, using a model, implementation of a first recommendation of the plurality of recommendations at a plurality of points in time based on one or more simulation parameters;
determine, responsive to simulation of the implementation of the first recommendation, a first point in time of the plurality of points in time to implement the first recommendation of the plurality of recommendations;
generate, responsive to determination of the first point in time, a user interface including:
a graphical representation to indicate the plurality of recommendations; and
an element to indicate the first point in time to implement the first recommendation of the plurality of recommendations;
receive, via the user interface, an adjustment to one or more recommendation parameters associated with the first recommendation;
determine a change to a point in time at which to implement a second recommendation of the plurality of recommendations based on the adjustment to the one or more recommendation parameters associated with the first recommendation; and
implement at least one of the first recommendation or the second recommendation by controlling one or more pieces of building equipment of the plurality of pieces of building equipment to adjust the emission impacts for the plurality of pieces of building equipment.

2. The BMS of claim 1, wherein the instructions further cause the one or more processors to:
identify, responsive to simulation of the implementation of the first recommendation, one or more points in time of the plurality of points in time predicted to correspond to a predetermined level of emission performance; and
determine, from the one or more points in time, the first point in time to implement the first recommendation of the plurality of recommendations based on an amount of time to obtain the predetermined level of emission performance.

3. The BMS of claim 1, wherein the user interface includes a plurality of selectable elements associated with the plurality of recommendations, and wherein the instructions further cause the one or more processors to:
receive, via a user device displaying the user interface, an indication of a selection of a first selectable element of the plurality of selectable elements, the first selectable element associated with the first recommendation of the plurality of recommendations;
identify, responsive to receipt of the indication, a modification to change implementation of the first recommendation from a second point in time to a third point in time; and
transmit, to the user device, one or more signals to cause the user device to update the user interface to reflect implementation of the first recommendation at the third point in time.

4. The BMS of claim 3, wherein the instructions further cause the one or more processors to:
input, into the model, one or more parameters associated with implementation of the first recommendation at the third point in time;
determine, using the model, an adjustment to an emission impact of the emission impacts for a first piece of building equipment of the plurality of pieces of building equipment based on implementation of the first recommendation at the third point in time; and
transmit, to the user device, one or more second signals to cause the user device to update the user interface to indicate the adjustment to the emission impact.

5. The BMS of claim 3, wherein the instructions further cause the one or more processors to:
input, into the model, one or more parameters associated with implementation of the first recommendation at the third point in time;
identify, using the model, one or more second recommendations of the plurality of recommendations to modify implementation from one or more fourth points in time to one or more fifth points in time based on the implementation of the first recommendation at the third point in time; and
transmit, to the user device, one or more second signals to cause the user device to update the user interface to indicate implementation of the one or more second recommendations at the one or more fifth points in time.

6. The BMS of claim 1, wherein the one or more simulation parameters correspond to at least one of:
the plurality of points in time; or
one or more Energy Conservation Measures associated with the first recommendation of the plurality of recommendations.

7. The BMS of claim 1, wherein the user interface includes a plurality of selectable elements associated with the plurality of recommendations, and wherein the instructions further cause the one or more processors to:
receive, from a user device displaying the user interface, an indication of a selection of a first selectable element of the plurality of selectable elements, the first selectable element associated with the first recommendation of the plurality of recommendations;
determine, responsive to receipt of the indication, that the selection defines a second point in time to implement the first recommendation; and
transmit, to the user device, one or more signals to cause the user device to update the user interface to reflect implementation of the first recommendation at the second point in time.

8. The BMS of claim 7, wherein the instructions further cause the one or more processors to:
modify, based on the selection defining the second point in time, one or more parameters associated with simulating implementation of the first recommendation to prevent an adjustment to the second point in time without receipt of a subsequent selection;
transmit, responsive to detection of the second point in time, one or more second signals to implement the first recommendation;
detect, responsive to implementation of the first recommendation, a change to an emission impact of the emission impacts to a first piece of building equipment of the plurality of pieces of building equipment; and
transmit, responsive to detection of the change, one or more third signals to cause the user device to update the user interface to indicate the change to the emission impact.

9. (canceled)

10. The BMS of claim 1, wherein implementation of the first recommendation results in an adjustment of an emission score for the building from a first value to a second value, and wherein the adjustment of the emission score for the building includes at least one of:
a reduction in carbon emissions for the building; or
a reduction in energy consumption for the building.

11. A method, comprising:
determining, by one or more processing circuits, based on emission information, emission impacts for a plurality of pieces of building equipment of a building;
generating, by the one or more processing circuits, using the emission impacts for the plurality of pieces of building equipment, a plurality of recommendations to adjust the emission impacts for the plurality of pieces of building equipment;
simulating, by the one or more processing circuits, using a model, implementation of a first recommendation of the plurality of recommendations at a plurality of points in time based on one or more simulation parameters;
determining, by the one or more processing circuits responsive to simulating the implementation of the first recommendation, a first point in time of the plurality of points in time to implement the first recommendation of the plurality of recommendations;
generating, by the one or more processing circuits responsive to determining the first point in time, a user interface including:
a graphical representation to indicate the plurality of recommendations; and
an element to indicate the first point in time to implement the first recommendation of the plurality of recommendations;
receiving, via the user interface, an adjustment to one or more recommendation parameters associated with the first recommendation;
determining a change to a point in time at which to implement a second recommendation of the plurality of recommendations based on the adjustment to the one or more recommendation parameters associated with the first recommendation; and
implementing at least one of the first recommendation or the second recommendation by controlling one or more pieces of building equipment of the plurality of pieces of building equipment to adjust the emission impacts for the plurality of pieces of building equipment.

12. The method of claim 11, comprising:
identifying, by the one or more processing circuits, responsive to simulation of the implementation of the first recommendation, one or more points in time of the plurality of points in time predicted to correspond to a predetermined level of emission performance; and
determining, by the one or more processing circuits, from the one or more points in time, the first point in time to implement the first recommendation of the plurality of recommendations based on an amount of time to obtain the predetermined level of emission performance.

13. The method of claim 11, wherein the user interface includes a plurality of selectable elements associated with the plurality of recommendations, and further comprising:
receiving, by the one or more processing circuits, from a user device displaying the user interface, an indication of a selection of a first selectable element of the plurality of selectable elements, the first selectable element associated with the first recommendation of the plurality of recommendations;
identifying, by the one or more processing circuits, responsive to receipt of the indication, a modification to change implementation of the first recommendation from a second point in time to a third point in time; and
transmitting, by the one or more processing circuits, to the user device, one or more signals to cause the user device to update the user interface to reflect implementation of the first recommendation at the third point in time.

14. The method of claim 13, further comprising:
inputting, by the one or more processing circuits, into the model, one or more parameters associated with implementation of the first recommendation at the third point in time;
determining, by the one or more processing circuits, using the model, an adjustment to an emission impact of the emission impacts for a first piece of building equipment of the plurality of pieces of building equipment based on implementation of the first recommendation at the third point in time; and
transmitting, by the one or more processing circuits, to the user device, one or more second signals to cause the user device to update the user interface to indicate the adjustment to the emission impact.

15. The method of claim 13, further comprising:
inputting, by the one or more processing circuits, into the model, one or more parameters associated with implementation of the first recommendation at the third point in time;
identifying, by the one or more processing circuits, using the model, one or more second recommendations of the plurality of recommendations to modify implementation from one or more fourth points in time to one or more fifth points in time based on the implementation of the first recommendation at the third point in time; and
transmitting, by the one or more processing circuits, to the user device, one or more second signals to cause the user device to update the user interface to indicate implementation of the one or more second recommendations at the one or more fifth points in time.

16. (canceled)

17. The method of claim 11, wherein implementation of the first recommendation results in an adjustment of an emission score for the building from a first value to a second value, and wherein the adjustment of the emission score for the building includes at least one of:
a reduction in carbon emissions for the building; or
a reduction in energy consumption for the building.

18. One or more non-transitory storage media storing instructions thereon that, when executed by one or more processors, cause the one or more processors to perform operations comprising:
determining, based on emission information, emission impacts for a plurality of pieces of building equipment of a building;
generating, using the emission impacts for the plurality of pieces of building equipment, a plurality of recommendations to adjust the emission impacts for the plurality of pieces of building equipment;
determining, based on predetermined criteria, a first point in time to implement a first recommendation of the plurality of recommendations;
generating, responsive to determining the first point in time, a user interface including:
a graphical representation to indicate the plurality of recommendations; and
an element to indicate the first point in time to implement the first recommendation of the plurality of recommendations;
receiving, via the user interface, an adjustment to one or more recommendation parameters associated with the first recommendation;
determining a change to a point in time at which to implement a second recommendation of the plurality of recommendations based on the adjustment to the one or more recommendation parameters associated with the first recommendation; and
implementing at least one of the first recommendation or the second recommendation by controlling one or more pieces of building equipment of the plurality of pieces of building equipment to adjust the emission impacts for the plurality of pieces of building equipment.

19. The one or more non-transitory storage media of claim 18, wherein the user interface includes a plurality of selectable elements associated with the plurality of recommendations, and wherein the instructions further cause the one or more processors to perform operations comprising:
receiving an indication of a selection of a first selectable element of the plurality of selectable elements, the first selectable element associated with the first recommendation of the plurality of recommendations;
determining, responsive to receipt of the indication, that the selection defines a second point in time to implement the first recommendation; and
updating the user interface to reflect implementation of the first recommendation at the second point in time.

20. The one or more non-transitory storage media of claim 18, wherein the instructions further cause the one or more processors to perform operations comprising:
modifying, based on a selection defining a second point in time, one or more parameters associated with simulating implementation of the first recommendation to prevent an adjustment to the second point in time without receipt of a subsequent selection;
transmitting, responsive to detection of the second point in time, one or more third signals to implement the first recommendation;
detecting, responsive to implementation of the first recommendation, a change to an emission impact of the emission impacts to a first piece of building equipment of the plurality of pieces of building equipment; and
updating, responsive to detection of the change, the user interface to indicate the change to the emission impact.
